(19) United States
(12) Patent Application Publication
(10) Pub. No.: US 2023/0189375 A1
(43) Pub. Date: Jun. 15, 2023

(54) METHOD AND DEVICE USED IN COMMUNICATION NODE FOR WIRELESS COMMUNICATION

(71) Applicants: Qiaoling YU, SHANGHAI (CN); Xiaobo ZHANG, SHANGHAI (CN)

(72) Inventors: Qiaoling YU, SHANGHAI (CN); Xiaobo ZHANG, SHANGHAI (CN)

(73) Assignee: SHANGHAI TUILUO COMMUNICATION TECHNOLOGY PARTNERSHIP (LIMITED PARTNERSHIP), SHANGHAI (CN)

(21) Appl. No.: 18/078,065

(22) Filed: Dec. 8, 2022

(30) Foreign Application Priority Data
Dec. 13, 2021 (CN) 202111514250.3

(51) Int. Cl. H04W 76/19; H04L 1/1812; H04W 74/08

(52) U.S. Cl. CPC H04W 76/19; H04L 1/1812; H04W 74/0841; H04W 80/02

(57) ABSTRACT

The present application provides a method and device in a communication node for wireless communications. A communication node transmits a first radio signal, and a first MAC CE in a first radio signal indicates a first candidate RS resource; receives a first signaling; monitors at least one CORESET with a QCL parameter(s) associated with a first candidate RS resource after a first effective time, and a first signaling indicates a first effective time; a first signaling satisfies all conditions in a first condition set; the first condition set comprises that a first signaling is identified by a first RNTI; whether the first condition set comprises a first target condition is related to a format of a first MAC CE; a first target condition is that a first signaling comprises a HARQ process number allocated to a PUSCH occupied by the first MAC CE and comprises a toggled NDI field.

### CROSS REFERENCE TO RELATED APPLICATIONS

This application claims the priority benefit of Chinese Patent Application No.202111514250.3, filed on December 13,2021 the full disclosure of which is incorporated herein by reference.

### BACKGROUND

### Technical Field

The present application relates to transmission methods and devices in wireless communication systems, and in particular to a multi-beam related transmission method and device.

### Related Art

3rd Generation Partnership Project (3GPP) introduced a Beam Failure Recovery (BFR) mechanism for a Special Cell (SpCell) in Release 15 (R15), and introduced a BFR mechanism for a Secondary Cell (SCell) in R16. 3GPP Radio Access Network (RAN) #80th meeting decided to carry out a Work Item (WI) of “Further enhancements on Multiple Input Multiple Output (MIMO) for New Radio (NR)” to enhance the BFR mechanism for Multiple Transmitter and Receiver Points (multi-TRP).

### Summary

3GPP has reached a consensus on R17′s need to support each TRP to independently perform a beam failure detection and recovery procedure. For the SpCell scenario, a random access procedure is triggered if a beam failure is detected in both TRPs and a BFR MAC CE enhanced in R17 is transmitted in the random access procedure, how to improve the performance of beam failure recovery needs to be enhanced.

To address the above problem, the present application provides a solution. It should be noted that though the present application only took the scenario of Uu interface for example in the statement above; the present application is also applicable to scenario such as sidelink, where similar technical effects can be achieved. Additionally, the adoption of a unified solution for various scenarios contributes to the reduction of hardware complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:
transmitting a first radio signal, the first radio signal comprising a first Medium Access Control (MAC) Control Element (CE), the first MAC CE being used for a BFR, a format of the first MAC CE being a candidate format in a first candidate format set or a candidate format in a second candidate format set, the first MAC CE being used to determine a first candidate Reference Signal (RS) resource; and
receiving a first signaling, the first signaling being transmitted on a Physical Downlink Control Channel (PDCCH); as a response to receiving the first signaling, monitoring at least one Control Resource Set (CORESET) with Quasi Co-Located (QCL) parameters associated with the first candidate RS resource after a first effective time, the first signaling being used to indicate the first effective time;
herein, the first signaling satisfies all conditions in a first condition set; one condition comprised in the first condition set is that the first signaling is identified by a first Radio Network Temporary Identifier (RNTI), and the first RNTI is allocated to the first node; whether the first condition set comprises a first target condition is related to whether the format of the first Medium Access Control Control Element (MAC CE) is a candidate format in the first candidate format set or a candidate format in the second candidate format set; the first target condition is that the first signaling comprises a first Hybrid Automatic Repeat Request (HARQ) process number and a toggled New Data Indicator (NDI) field, and the first HARQ process number is a HARQ process number allocated to a Physical uplink shared channel (PUSCH) occupied by the first MAC CE; the first candidate format set comprises at least a first candidate format, and the first candidate format only can indicate one candidate RS resource for a serving cell at most; the second candidate format set comprises at least a second candidate format, and a maximum number of candidate RS resources that can be indicated by the second candidate format for a serving cell is greater than 1.

In one embodiment, a problem to be solved in the present application includes: when both an RS resource associated with a random access preamble and the first candidate RS resource are associated to a same TRP, QCL parameters of which RS resource is used to detect a corresponding CORESET.

In one embodiment, a problem to be solved in the present application includes: when the first candidate RS resource comes into effect.

In one embodiment, a problem to be solved in the present application includes: how to improve performance of beam failure recovery.

In one embodiment, characteristics of the above method comprise: the first radio signal is transmitted on a first cell.

In one embodiment, characteristics of the above method comprise: the first candidate RS resource belongs to a first cell.

In one embodiment, characteristics of the above method comprise: the first candidate RS resource is indicated in the first MAC CE, and a time when the first candidate RS resource comes into effect does not depend on the first target condition.

In one embodiment, characteristics of the above method comprise: the first candidate RS resource is indicated in the first MAC CE, and QCL parameter(s) associated with the first candidate RS resource is(are) used as QCL parameter(s) of at least one CORESET.

In one embodiment, advantages of the above method include: enable the first candidate RS resource coming into effect as soon as possible.

In one embodiment, advantages of the above method include: improving the reliability of a BFR.

According to one aspect of the present application, it is characterized in that whether the first condition set comprises a first target condition is related to whether the first cell is a PCell or an SCell.

In one embodiment, characteristics of the above method comprise: a format of the first MAC CE is a candidate format in the first candidate format set, the first MAC CE is used to determine the first candidate RS resource, and the first condition set comprises the first target condition; the first cell is an SCell.

In one embodiment, characteristics of the above method comprise: a format of the first MAC CE is a candidate format in the second candidate format set, the first MAC CE is used to determine the first candidate RS resource, and the first condition set comprises the first target condition; the first cell is an SCell.

In one embodiment, characteristics of the above method comprise: a format of the first MAC CE is a candidate format in the first candidate format set, the first MAC CE is used to determine the first candidate RS resource, and the first condition set does not comprise the first target condition; the first cell is a PCell.

In one embodiment, characteristics of the above method comprise: a format of the first MAC CE is a candidate format in the second candidate format set, the first MAC CE is used to determine the first candidate RS resource, and the first condition set does not comprise the first target condition; the first cell is a PCell.

According to one aspect of the present application, comprising:

as a response to receiving the first signaling, adopting a spatial filter associated with the first candidate RS resource after the first effective time to transmit a PUCCH.

According to one aspect of the present application, it is characterized in that a PDCCH used to carry the first signaling and the first candidate RS resource have same antenna port quasi co-location properties.

According to one aspect of the present application, comprising:
transmitting a first random access preamble in a first random access procedure, the first random access preamble being used to determine a first uplink grant;
herein, the first uplink grant is used to carry the first radio signal; the first signaling is used to determine that the first random access procedure is successfully completed.

In one embodiment, when the format of the first MAC CE is a candidate format in the second candidate format set, one condition comprised in the first condition set is that the first signaling is used to determine that the first random access procedure is successfully completed.

According to one aspect of the present application, comprising:
receiving a first message, the first message indicating at least a first RS resource group, the first RS resource group comprising at least one RS resource; and
whenever radio link quality evaluated according to the first RS resource group is worse than a first threshold, increasing a first counter by 1;

herein, the first candidate RS resource is associated with the first RS resource group; at least the first counter reaching a first value being used to determine to initiate the first random access procedure; the first threshold is configurable; the first value is configurable, and the first value is a positive integer.

According to one aspect of the present application, comprising:
the first message indicating at least a second RS resource group, the second RS resource group comprising at least one RS resource; and
whenever radio link quality evaluated according to the second RS resource group is worse than a second threshold, increasing a second counter by 1;
herein, the first RS resource group and the second RS resource group belong to a same serving cell; at least a former of the first counter reaching a first value or the second counter reaching a second value is used to determine to initiate the first random access procedure; the second threshold is configurable; the second value is configurable, and the second value is a positive integer.

According to one aspect of the present application, comprising:

as a response to the first counter reaching the first value and the second counter reaching the second value, initiating the first random access procedure.

According to one aspect of the present application, comprising:
as a response to the first counter reaching the first value, triggering a first BFR; as a response to the first SR being triggered, initiating the first random access procedure;
herein, the first SR being triggered is used to determine to initiate the first random access procedure.

The present application provides a method in a second node for wireless communications, comprising:
receiving a first radio signal, the first radio signal comprising a first MAC CE, the first MAC CE being used for a BFR, a format of the first MAC CE being a candidate format in a first candidate format set or a candidate format in a second candidate format set, the first MAC CE being used to determine a first candidate RS resource; and
transmitting a first signaling, the first signaling being transmitted on a PDCCH;
herein, as a response to the first signaling being received by a transmitter of the first radio signal, a transmitter of the first radio signal monitors at least one CORESET with QCL parameter(s) associated with the first candidate RS resource after a first effective time, the first signaling is used to indicate the first effective time; the first signaling satisfies all conditions in a first condition set; one condition comprised in the first condition set is that the first signaling is identified by a first RNTI, and the first RNTI is allocated to a transmitter of the first radio signal; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.

According to one aspect of the present application, comprising:
receiving a PUCCH;
herein, as a response to the first signaling being received by a transmitter of the first radio signal, a transmitter of the first radio signal transmits a PUCCH with a spatial filer associated with the first candidate RS resource after the first effective time.

According to one aspect of the present application, it is characterized in that a PDCCH used to carry the first signaling and the first candidate RS resource have same antenna port quasi co-location properties.

According to one aspect of the present application, comprising:
receiving a first random access preamble in a first random access procedure, the first random access preamble being used to determine a first uplink grant;
herein, the first uplink grant is used to carry the first radio signal; the first signaling is used to determine that the first random access procedure is successfully completed.

In one embodiment, when the format of the first MAC CE is a candidate format in the second candidate format set, one condition comprised in the first condition set is that the first signaling is used to determine that the first random access procedure is successfully completed.

According to one aspect of the present application, comprising:
transmitting a first message, the first message indicating at least a first RS resource group, the first RS resource group comprising at least one RS resource; and
herein, whenever radio link quality evaluated according to the first RS resource group is worse than a first threshold, a first counter is increased by 1; the first candidate RS resource is associated with the first RS resource group; at least the first counter reaching a first value being used to determine to initiate the first random access procedure; the first threshold is configurable; the first value is configurable, and the first value is a positive integer.

According to one aspect of the present application, it is characterized in that the first message indicates at least a second RS resource group, the second RS resource group comprises at least one RS resource; herein, whenever radio link quality evaluated according to the second RS resource group is worse than a second threshold, a second counter is increased by 1; the first RS resource group and the second RS resource group belong to a same serving cell; at least a former of the first counter reaching a first value or the second counter reaching a second value is used to determine to initiate the first random access procedure; the second threshold is configurable; the second value is configurable, and the second value is a positive integer.

According to one aspect of the present application, it is characterized in that as a response to the first counter reaching the first value and the second counter reaching the second value, the first random access procedure is initiated.

According to one aspect of the present application, it is characterized in that as a response to the first counter reaching the first value, a first BFR is triggered; as a response to the first BFR being triggered, a first SR is triggered; the first SR being triggered is used to determine to initiate the first random access procedure.

The present application provides a first node for wireless communications, comprising:
a first transmitter, transmitting a first radio signal, the first radio signal comprising a first MAC CE, the first MAC CE being used for a BFR, a format of the first MAC CE being a candidate format in a first candidate format set or a candidate format in a second candidate format set, the first MAC CE being used to determine a first candidate RS resource;
a first receiver, receiving a first signaling, the first signaling being transmitted on a PDCCH; as a response to receiving the first signaling, monitoring at least one CORESET with QCL parameter(s) associated with the first candidate RS resource after a first effective time, the first signaling being used to indicate the first effective time;
herein, the first signaling satisfies all conditions in a first condition set; one condition comprised in the first condition set is that the first signaling is identified by a first RNTI, and the first RNTI is allocated to the first node; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.

The present application provides a second node for wireless communications, comprising:
a second receiver, receiving a first radio signal, the first radio signal comprising a first MAC CE, the first MAC CE being used for a BFR, a format of the first MAC CE being a candidate format in a first candidate format set or a candidate format in a second candidate format set, the first MAC CE being used to determine a first candidate RS resource;
a second transmitter, transmitting a first signaling, the first signaling being transmitted on a PDCCH;
herein, as a response to the first signaling being received by a transmitter of the first radio signal, a transmitter of the first radio signal monitors at least one CORESET with QCL parameter(s) associated with the first candidate RS resource after a first effective time, the first signaling is used to indicate the first effective time; the first signaling satisfies all conditions in a first condition set; one condition comprised in the first condition set is that the first signaling is identified by a first RNTI, and the first RNTI is allocated to a transmitter of the first radio signal; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.

In one embodiment, the present application has the following advantages over conventional schemes:
-it enables the first candidate RS resource coming into effect as soon as possible;
-it improves the reliability of the BFR.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmissions of a first radio signal and a first signaling according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a flowchart of radio signal transmission according to another embodiment of the present application;

FIG. 7 illustrates a flowchart of radio signal transmission according to another embodiment of the present application;

FIG. 8 illustrates a flowchart of radio signal transmission according to another embodiment of the present application;

FIG. 9 illustrates a schematic diagram of a PDCCH used for carrying a first signaling and a first candidate RS resource having same antenna port quasi co-location properties according to one embodiment of the present application;

FIG. 10 illustrates a structure block diagram of a processor in a first node according to one embodiment of the present application;

FIG. 11 illustrates a structure block diagram of a processor in a second node according to one embodiment of the present application;

FIG. 12 illustrates a schematic diagram of monitoring at least one CORESET with QCL parameter(s) associated with a first random access preamble after a first effective time.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of transmissions of a first radio signal and a first signaling according to one embodiment of the present application, as shown in FIG. 1. In FIG. 1, each step represents a step, it should be particularly noted that the sequence order of each box herein does not imply a chronological order of steps marked respectively by these boxes.

In embodiment 1, a first node in the present application transmits a first radio signal in step 101, the first radio signal comprises a first MAC CE, the first MAC CE is used for a BFR, a format of the first MAC CE is a candidate format in a first candidate format set or a candidate format in a second candidate format set, the first MAC CE is used to determine a first candidate RS resource; in step 102, receives a first signaling, the first signaling is transmitted on a PDCCH; in step 103, as a response to receiving the first signaling, monitors at least one CORESET with QCL parameter(s) associated with the first candidate RS resource after a first effective time, the first signaling is used to indicate the first effective time; herein, the first signaling satisfies all conditions in a first condition set; one condition comprised in the first condition set is that the first signaling is identified by a first RNTI, and the first RNTI is allocated to the first node; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.

In one embodiment, a receiver of the first radio signal is a maintenance base station of a first cell.

In one embodiment, the first radio signal is transmitted on a first cell.

In one embodiment, the first radio signal is a MAC layer signaling.

In one embodiment, the first radio signal is a MAC Protocol Data Unit (PDU).

In one embodiment, the first radio signal comprises at least one MAC PDU.

In one embodiment, the first radio signal comprises at least one MAC subPDU.

In one embodiment, the first radio signal comprises at least one MAC sub-header.

In one embodiment, the first radio signal comprises at least one MAC Service Data Unit (SDU).

In one embodiment, the first radio signal comprises at least one MAC CE.

In one embodiment, the first radio signal comprises at least one MAC CE, or at least one MAC SDU, or at least one MAC sub-header.

In one embodiment, the first radio signal is a MAC PDU, and the MAC PDU comprises the first MAC CE.

In one embodiment, the first radio signal is a MAC subPDU, and the MAC subPDU comprises the first MAC CE.

In one embodiment, the first radio signal comprises a C-RNTI MAC CE.

In one embodiment, the first radio signal is an Msg3.

In one embodiment, the first radio signal is an MsgA.

In one embodiment, the first radio signal is received in a running period of ra-ContentionResolutionTimer.

In one embodiment, the first radio signal is received in a running period of msgB-ResponseWindow.

In one embodiment, the phrase of the first MAC CE being used for a BFR refers to: the first MAC CE is used for a BFR procedure.

In one embodiment, the phrase of the first MAC CE being used for a BFR refers to: the first MAC CE is used for a beam failure detection and recovery procedure.

In one embodiment, the phrase of the first MAC CE being used for a BFR refers to: the first MAC CE is used to indicate that a beam failure is detected.

In one embodiment, the phrase of the first MAC CE being used for a BFR refers to: the first MAC CE is used to indicate a candidate beam.

In one embodiment, the phrase of the first MAC CE being used for a BFR refers to: the first MAC CE is used to indicate a new Synchronization Signal Block (SSB) or a Channel state information Reference signal (CSI-RS) to a base station when a beam failure is detected.

In one embodiment, the phrase of the first MAC CE being used for a BFR refers to: the first MAC CE is used to indicate beam failure information.

In one embodiment, the first MAC CE is a BFR MAC CE.

In one embodiment, the first MAC CE is an enhanced BFR MAC CE.

In one embodiment, the first MAC CE comprises a field, the field indicates an index of the first cell, and the field is set to 1.

In one subembodiment of the above embodiment, the field is a Ci field.

In one embodiment, the first candidate format set comprises at least one candidate format.

In one embodiment, the first candidate format set comprises four candidate formats.

In one embodiment, a number of candidate formats in the first candidate format set is the same as a number of candidate formats in the second candidate format set.

In one embodiment, a number of candidate formats in the first candidate format set is different from a number of candidate formats in the second candidate format set.

In one embodiment, a Logical Channel ID (LCID) corresponding to any candidate format in the first candidate format set is different from an LCID corresponding to any candidate format in the second candidate format set.

In one embodiment, an LCID corresponding to a candidate format in the first candidate format set is the same as an LCID corresponding to a candidate format in the second candidate format set.

In one embodiment, a MAC sub-header corresponding to any candidate format in the first candidate format set is different from a MAC sub-header corresponding to any candidate format in the second candidate set.

In one embodiment, a MAC sub-header corresponding to a candidate format in the first candidate format set is the same as a MAC sub-header corresponding to a candidate format in the second candidate format set.

In one embodiment, a candidate format in the first candidate format set is a format of a BFR MAC CE in TS 38.321.

In one embodiment, a candidate format in the first candidate format set is a format of a truncated BFR MAC CE in TS 38.321.

In one embodiment, a candidate format in the first candidate format set is a format of a BFR MAC CE with one octet Ci field in section 6.1.3.23 in TS 38.321; a candidate format in the first candidate format set is a format of a truncated BFR MAC CE with one octet Ci field in section 6.1.3.23 in TS 38. 321; a candidate format in the first candidate format set is a format of a BFR MAC CE with four octets Ci field in section 6.1.3.23 in TS 38. 321; a candidate format in the first candidate format set is a format of a truncated BFR MAC CE with four octets Ci field in section 6.1.3.23 in TS 38.321.

In one embodiment, a candidate format in the first candidate format set corresponds to an LCID index, and the LCID index corresponds to an LCID code-point; the LCID index is equal to 50 (the LCID code-point is equal to 50).

In one embodiment, a candidate format in the first candidate format set corresponds to an LCID index, and the LCID index corresponds to an LCID code-point; the LCID index is equal to 51 (the LCID code-point is equal to 51).

In one embodiment, a candidate format in the first candidate format set corresponds to an eLCID index, and the eLCID index corresponds to an eLCID code-point; the eLCID index is equal to 314 (the eLCID code-point is equal to 250).

In one embodiment, a candidate format in the first candidate format set corresponds to an eLCID index, and the eLCID index corresponds to an eLCID code-point; the eLCID index is equal to 315 (the eLCID code-point is equal to 251).

In one embodiment, the second candidate format set comprises at least one candidate format.

In one embodiment, the second candidate format set comprises four candidate formats.

In one embodiment, the second candidate format set comprises two candidate formats.

In one embodiment, a candidate format in the second candidate format set corresponds to an LCID index, and the LCID index corresponds to an LCID code-point; the LCID index is equal to 50 (the LCID code-point is equal to 50).

In one embodiment, a candidate format in the second candidate format set corresponds to an LCID index, and the LCID index corresponds to an LCID code-point; the LCID index is equal to 51 (the LCID code-point is equal to 51).

In one embodiment, a candidate format in the second candidate format set corresponds to an eLCID index, and the eLCID index corresponds to an eLCID code-point; the eLCID index is equal to 314 (the eLCID code-point is equal to 250).

In one embodiment, a candidate format in the second candidate format set corresponds to an eLCID index, and the eLCID index corresponds to an eLCID code-point; the eLCID index is equal to 315 (the eLCID code-point is equal to 251).

In one embodiment, a candidate format in the second candidate format set corresponds to an index of an LCID, and the LCID index corresponds to an LCID code-point; the LCID index is not equal to 50 (the LCID code-point is not equal to 50), and the LCID index is not equal to 51 (the LCID code-point is not equal to 51).

In one embodiment, a candidate format in the second candidate format set corresponds to an eLCID index, and the eLCID index corresponds to an eLCID code-point; the eLCID index is not equal to 314 (the eLCID code-point is not equal to 250), and the eLCID index is not equal to 315 (the eLCID code-point is not equal to 251).

In one embodiment, a number of RS resource group(s) used for a beam failure detection in the first cell being equal to 1 is used to determine that the format of the first MAC CE is a candidate format in the first format set.

In one embodiment, a number of RS resource groups used for a beam failure detection in the first cell being greater than 1 is used to determine that the format of the first MAC CE is a candidate format in the second format set.

In one embodiment, the phrase of the first MAC CE being used to determine a first candidate RS resource comprises: the first MAC CE comprises an index of the first candidate RS resource.

In one embodiment, the phrase of the first MAC CE being used to determine a first candidate RS resource comprises: the first MAC CE explicitly indicates the first candidate RS resource.

In one embodiment, the phrase of the first MAC CE being used to determine a first candidate RS resource comprises: the first MAC CE implicitly indicates the first candidate RS resource.

In one embodiment, the phrase of the first MAC CE being used to determine a first candidate RS resource comprises: a field in the first MAC CE is used to determine the first candidate RS resource.

In one embodiment, the phrase of the first MAC CE being used to determine a first candidate RS resource comprises: a field in the first MAC CE indicates an index of the first candidate RS resource.

In one embodiment, the first candidate RS resource belongs to a first cell.

In one embodiment, the first candidate RS resource belongs to a TRP in a first cell.

In one embodiment, the first candidate RS resource belongs to a first candidate RS resource group, and each RS resource in the first candidate RS resource group is used for a candidate beam of a BFR.

In one embodiment, the first candidate RS resource belongs to the first second cell in the present application.

In one subembodiment of the embodiment, the second cell is configured.

In one subembodiment of the embodiment, the second cell is not configured.

In one embodiment, the first candidate RS resource is an RS resource.

In one embodiment, the first candidate RS resource is an SSB.

In one embodiment, the first candidate RS resource is a CSI-RS.

In one embodiment, the first candidate RS resource is a CSI-RS with CSI-RSRP greater than a threshold.

In one embodiment, the first candidate RS resource is an SSB with SS-RSRP greater than another threshold.

In one embodiment, the first candidate RS resource is a CSI-RS with a CSI-RSRP greater than a threshold; or, the first candidate RS resource is an SSB with an SS-RSRP greater than another threshold.

In one embodiment, the above threshold is an rsrp-ThresholdBFR.

In one embodiment, the above another threshold is an rsrp-ThresholdBFR.

In one embodiment, the above threshold or the above another threshold is equal.

In one embodiment, the above threshold or the above another threshold is not equal.

In one embodiment, the above threshold or the above another threshold is measured by dBm.

In one embodiment, a transmitter of the first signaling is a maintenance base station of the first cell.

In one embodiment, the first signaling is transmitted on the first cell.

In one embodiment, the first signaling is a PDCCH transmission.

In one embodiment, the first signaling is a PDCCH reception.

In one embodiment, the first signaling is a physical-layer signaling.

In one embodiment, the first signaling is an MSG4.

In one embodiment, the first signaling is an MSGB.

In one embodiment, the first signaling is received on a PDCCH.

In one embodiment, time-frequency resources carrying the first signaling belong to a PDCCH.

In one embodiment, the first signaling is used to schedule an uplink transmission.

In one embodiment, the first signaling is used to schedule a downlink transmission.

In one embodiment, the first signaling is used to schedule a PUSCH.

In one embodiment, the first signaling is used to schedule a PDSCH.

In one embodiment, the first signaling adopts Downlink control information (DCI) format 0-0.

In one embodiment, the first signaling adopts DCI format 0-1.

In one embodiment, the first signaling adopts DCI format 0-2.

In one embodiment, the first signaling adopts DCI format 1-0.

In one embodiment, the first signaling adopts DCI format 1-1.

In one embodiment, the first signaling adopts DCI format 1-2.

In one embodiment, the first effective time refers to: the first effective time.

In one embodiment, the first effective time comprises a time interval.

In one embodiment, the first effective time comprises a time.

In one embodiment, the first effective time refers to an effective time.

In one embodiment, the first effective time refers to a time when the first candidate RS resource is applied.

In one embodiment, the first effective time is related to a processing latency.

In one embodiment, the first effective time is related to hardware.

In one embodiment, the first MAC CE comes into effect after a first effective time.

In one embodiment, the first candidate RS resource comes into effect after a first effective time.

In one embodiment, the first candidate RS resource is applied after a first effective time.

In one embodiment, the first candidate RS resource is referenced after a first effective time.

In one embodiment, the phrase of being after a first effective time comprises coming into effect after the first effective time.

In one embodiment, the phrase of being after a first effective time comprises coming into effect after an end time of the first effective time.

In one embodiment, the phrase of the first signaling being used to indicate the first effective time comprises: a time for receiving the first signaling is used to determine the first effective time.

In one embodiment, the phrase of the first signaling being used to indicate the first effective time comprises: a last symbol of the first signaling is used to determine the first effective time.

In one embodiment, the phrase of the first signaling being used to indicate the first effective time comprises: the first effective time is related to a time when a last symbol of the first signaling is received.

In one embodiment, the phrase of the first signaling being used to indicate the first effective time comprises: the first effective time refers to a time after N1 symbols from a time when a last symbol of the first signaling is received.

In one embodiment, the phrase of the first signaling being used to indicate the first effective time comprises: the first effective time refers to a time after N1 symbols from a time starting from a symbol received after a last symbol of the first signaling is received, N1 being a positive integer.

In one embodiment, the above N1 is equal to 27.

In one embodiment, the above N1 is equal to 28.

In one embodiment, the above N1 is equal to 29.

In one embodiment, the above N1 is not greater than 64.

In one embodiment, the phrase of: “monitoring at least one CORESET with QCL parameter(s) associated with the first candidate RS resource after a first effective time, the first signaling being used to indicate the first effective time” can be replaced as: after N1 symbols from a last symbol of the first signaling is received, QCL parameter(s) associated with the first candidate RS resources is(are) adopted to monitor at least one CORESET.

In one subembodiment of the embodiment, the phrase of “ after N1 symbols from a last symbol of the first signaling is received” refers to: after N1 symbols from a last symbol of a first signaling.

In one subembodiment of the embodiment, the phrase of “monitoring at least one CORESET with QCL parameter(s) associated with the first candidate RS resources” refers to: it is assumed that same quasi-collocation parameters or quasi-co-location parameters as the ones associated with index the first candidate RS resource for PDCCH monitoring in at least one CORESET.

In one embodiment, the QCL parameter(s) comprises(comprise): spatial Rx parameter(s).

In one embodiment, the QCL parameter(s) refers(refer) to: quasi-co-location (QCL) parameter(s).

In one embodiment, the QCL parameter(s) refers(refer) to: quasi-collocation (QCL) parameter(s).

In one embodiment, the QCL parameter(s) refers(refer) to: antenna port QCL parameter(s).

In one embodiment, the QCL parameter(s) refers(refer) to: DMRS quasi co-location parameter(s).

In one embodiment, the QCL parameter(s) refers(refer) to: antenna port QCL parameter(s).

In one embodiment, the QCL parameter(s) refers(refer) to: spatial Rx parameter(s).

In one embodiment, the QCL parameter(s) comprises(comprise): QCL type.

In one embodiment, typically, the QCL parameter(s) is(are) antenna port QCL parameter(s).

In one embodiment, channel properties on some antenna port symbols can be inferred from another antenna port, it is assumed that these two ports are QCL.

In one embodiment, the spatial Rx parameter(s) is(are) configured through an RRC message.

In one embodiment, the spatial Rx parameter(s) is(are) used to determine differences of channel large-scale parameters incurred by the change of analog beamforming.

In one embodiment, the spatial Rx parameter(s) is(are) spatial RX parameter(s).

In one embodiment, the spatial Rx parameter(s) is(are) spatial reception parameter(s).

In one embodiment, the spatial Rx parameter(s) comprises(comprise): large-scale parameters.

In one embodiment, the spatial Rx parameter(s) comprises(comprise): a channel related matrix.

In one embodiment, the spatial Rx parameter(s) comprises(comprise): a transmitting beam.

In one embodiment, the spatial Rx parameter(s) comprises(comprise): a receiving beam.

In one embodiment, the spatial Rx parameter(s) comprises(comprise): a transmitting/receiving beam pair.

In one embodiment, the spatial Rx parameter(s) comprises(comprise) at least one of a large-scale parameter channel, or a related matrix, or a transmitting beam, or a receiving beam, or a transmitting/ receiving beam pair.

In one embodiment, a type of the QCL comprises QCL-TypeA.

In one embodiment, a type of the QCL comprises QCL-TypeB.

In one embodiment, a type of the QCL comprises QCL-TypeC.

In one embodiment, a type of the QCL comprises QCL-TypeD.

In one embodiment, the phrase of QCL parameter(s) associated with the first candidate RS resource comprises: QCL parameter(s) of an antenna port is(are) the same as an index of the first candidate RS resource.

In one embodiment, the phrase of QCL parameter(s) associated with the first candidate RS resource comprises: the first candidate RS resource is used as a reference of the QCL parameter(s).

In one embodiment, the phrase of QCL parameter(s) associated with the first candidate RS resource comprises: the first candidate RS resource is used as QCL reference(s).

In one embodiment, the phrase of QCL parameter(s) associated with the first candidate RS resource comprises: QCL parameter(s) is(are) the same as the first candidate RS resource.

In one embodiment, an index of a CORESET in the at least one CORESET is equal to 0.

In one embodiment, an index of a CORESET in the at least one CORESET is equal to 1.

In one embodiment, an index of a CORESET in the at least one CORESET is equal to 2.

In one embodiment, an index of a CORESET in the at least one CORESET is equal to 3.

In one embodiment, an index of a CORESET in the at least one CORESET is equal to 4.

In one embodiment, a CORESET in the at least one CORESET is ControlResourceSet#0.

In one embodiment, a CORESET in the at least one CORESET is associated with the first cell.

In one embodiment, all CORESETs in the at least one CORESET are associated with the first cell.

In one embodiment, a CORESET in the at least one CORESET is associated with a candidate RS resource group in the first cell, and the candidate RS resource group comprises the first candidate RS resource.

In one embodiment, all CORESETs in the at least one CORESET is associated with a candidate RS resource group in the first cell, and the candidate RS resource group comprises the first candidate RS resource.

In one embodiment, the at least one CORESET refers to: at least one CORESET that is associated to a candidate RS resource group to which the first candidate RS resource belongs.

In one embodiment, the at least one CORESET refers to: all CORESETs that are associated to a candidate RS resource group to which the first candidate RS resource belongs.

In one embodiment, the at least one CORESET refers to: one CORESET that is associated to a candidate RS resource group to which the first candidate RS resource belongs.

In one embodiment, a candidate RS resource group to which the first candidate RS resource belongs can be replaced as: a TRP to which the first candidate RS resource belongs.

In one embodiment, the at least one CORESET is configured to the first node.

In one embodiment, the at least one CORESET is used to search downlink control information.

In one embodiment, the at least one CORESET is a CORESET specific to the first node.

In one embodiment, the at least one CORESET is a CORESET common to the first cell.

In one embodiment, the phrase of the first signaling satisfying all conditions in a first condition set comprises: at least one of a format of the first signaling, or information carried by the first signaling or an identifier of the first node associated with the first signaling satisfies all conditions in a first condition set.

In one embodiment, the phrase of the first signaling satisfying all conditions in a first condition set comprises: the first signaling satisfies all conditions in a first condition set at the same time.

In one embodiment, the phrase of the first signaling satisfying all conditions in a first condition set comprises: the first signaling satisfies any condition in the first condition set.

In one embodiment, the phrase of the first signaling satisfying all conditions in a first condition set comprises: the first signaling satisfies each condition in the first condition set.

In one embodiment, as a response to receiving the first signaling, if the first signaling satisfies all conditions in the first condition set, at least one CORESET is monitored with QCL parameter(s) associated with the first candidate RS resource after the first effective time.

In one embodiment, as a response to receiving the first signaling, if the first signaling does not satisfy any condition in the first condition set, at least one CORESET is not monitored with QCL parameter(s) associated with the first candidate RS resource after the first effective time.

In one embodiment, the phrase of the first signaling being identified by a first RNTI comprises: the first signaling is addressed to the first RNTI.

In one embodiment, the phrase of the first signaling being identified by a first RNTI comprises: the first signaling is scrambled by the first RNTI.

In one embodiment, the phrase of the first signaling being identified by a first RNTI comprises: Cyclic Redundancy Check (CRC) scrambling is performed by the first RNTI on the first signaling.

In one embodiment, the phrase of the first signaling being identified by a first RNTI comprises: CRC scrambling of the first signaling adopts the first RNTI.

In one embodiment, the phrase of the first RNTI being allocated to the first node comprises: the first RNTI is an identifier of the first node.

In one embodiment, the phrase of the first RNTI being allocated to the first node comprises: the first RNTI is an identifier of the first node in the first cell.

In one embodiment, the phrase of the first RNTI being allocated to the first node comprises: the first RNTI is an identifier of the first node in a cell group to which the first cell belongs.

In one embodiment, the first RNTI is an RNTI.

In one embodiment, the first RNTI is a C-RNTI.

In one embodiment, the first RNTI is a Modulation and coding scheme C-RNTI (MCS-C-RNTI).

In one embodiment, the first RNTI is a C-RNTI or an MCS-C-RNTI.

In one embodiment, when the format of the first MAC CE is a candidate format in the first candidate format set, one condition comprised in the first condition set is that the first signaling is identified by a first RNTI, and the first RNTI is allocated to the first node.

In one embodiment, when the format of the first MAC CE is a candidate format in the second candidate format set, one condition comprised in the first condition set is that the first signaling is identified by a first RNTI, and the first RNTI is allocated to the first node.

In one embodiment, the phrase of whether the first condition set comprises a first target condition being related to whether the format of the first MAC CE is a candidate format in the first candidate format set or a candidate format in the second candidate format set can be replaced as: whether the format of the first MAC CE is a candidate format in the first candidate format set or a candidate format in the second candidate set is used to determine whether the first condition set comprises the first target condition.

In one embodiment, the phrase of whether the first condition set comprises a first target condition being related to whether the format of the first MAC CE is a candidate format in the first candidate format set or a candidate format in the second candidate format set can be replaced as: at least whether the format of the first MAC CE is a candidate format in the first candidate format set or a candidate format in the second candidate set is used to determine whether the first condition set comprises the first target condition.

In one embodiment, the phrase of whether the first condition set comprises a first target condition being related to whether the format of the first MAC CE is related to a candidate format in the first candidate format set or a candidate format in the second candidate format set can be replaced as: whether the first condition set comprises the first target condition is related to at least whether the format of the first MAC CE is related to a candidate format in the first candidate format set or a candidate format in the second candidate format set.

In one embodiment, the phrase of whether the first condition set comprises a first target condition being related to whether the format of the first MAC CE is related to a candidate format in the first candidate format set or a candidate format in the second candidate format set comprises: when the format of the first MAC CE is a candidate format in the first candidate format set, the first condition set comprises the first target condition; when the format of the first MAC CE is a candidate format in the second candidate format set, the first condition set does not comprise the first target condition.

In one embodiment, a PUSCH occupied by the first MAC CE is associated with an MSGA.

In one embodiment, a PUSCH occupied by the first MAC CE is scheduled by a Random Access Response (RAR).

In one embodiment, a PUSCH occupied by the first MAC CE is scheduled by fallbackRAR.

In one embodiment, a PUSCH occupied by the first MAC CE is scheduled by a TC-RNTI scrambled CRC.

In one embodiment, a PUSCH occupied by the first MAC CE is scheduled by a C-RNTI or MCS-C-RNTI scrambled DCI.

In one embodiment, the first HARQ process number is equal to 0.

In one embodiment, the first HARQ process number is an integer not less than 0 and not greater than 15.

In one embodiment, the first HARQ process number is an integer not less than 1 and not greater than 15.

In one embodiment, the NDI field is a New Data Indicator field.

In one embodiment, the meaning of the first signaling comprising a toggled NDI field refers to: it is assumed that a value of an NDI field in the first signaling is toggled.

In one embodiment, the meaning of the first signaling comprising a toggled NDI field refers to: PUSCH resources indicated by the first signaling are used for a new data transmission.

In one embodiment, the meaning of the first signaling comprising a toggled NDI field refers to: compared with a value of an NDI field associated with a previous transmission of the first HARQ process number, a value of an NDI field in the first signaling is toggled.

In one embodiment, the meaning of the first signaling comprising a toggled NDI field refers to: a value of an NDI field associated with a previous transmission of the first HARQ process number is equal to 1, a value of an NDI field in the first signaling is equal to 0; or, a value of an NDI field associated with a previous transmission of the first HARQ process number is equal to 0, a value of an NDI field in the first signaling is equal to 1.

In one embodiment, the meaning of the toggled is toggle.

In one embodiment, the first signaling comprising a field is used to indicate the first HARQ process number.

In one embodiment, the first signaling comprises a HARQ process number field, and the HARQ process number field indicates the first HARQ process number.

In one embodiment, the first signaling comprises a HARQ process number field, and the HARQ process number field is set as the first HARQ process number.

In one embodiment, the phrase of the first signaling comprising a first HARQ process number and comprising a toggled NDI field comprises: a field in the first signaling indicates the first HARQ process number, and the first signaling comprising an NDI field indicates that an NDI is toggled.

In one embodiment, each candidate format in the first candidate format set only can indicate one BFR information for a serving cell at most; a maximum number of BFR information that each candidate format in the second candidate format set can indicate is greater than 1.

In one embodiment, each candidate format in the first candidate format set only can indicate a candidate RS resource for a serving cell at most; a maximum number of candidate RS resources that each candidate format in the second candidate format set can indicate is greater than 1.

In one embodiment, the first candidate format only can indicate one BFR information for a serving cell at most.

In one embodiment, the first candidate format is a candidate format in the first candidate format set.

In one embodiment, the first candidate format is any candidate format in the first candidate format set.

In one embodiment, the phrase of the first candidate format only can indicate a candidate RS resource for a serving cell at most comprises: the first candidate format only can comprise one BFR information for a serving cell at most; the BFR information is an octet comprising an availability indication (AC) field, the AC field indicates whether there exists a candidate RS ID field, and the candidate RS ID field indicates the candidate RS resource.

In one subembodiment of the above embodiment, the first candidate format comprises one BFR information for a serving cell.

In one subembodiment of the above embodiment, the first candidate format does not comprise any BFR information for a serving cell.

In one subembodiment of the above embodiment, the AC field indicates that there exists a candidate RS ID field.

In one subembodiment of the above embodiment, the AC field indicates that there does not exist a candidate RS ID field.

In one subembodiment of the above embodiment, the candidate RS ID field indicates an index of an SSB with SS-RSRP higher than rsrp-ThresholdBFR in a candidateBeamRSSCellList, or an index of a CSI-RS with CSI-RSRP higher than rsrp-ThresholdBFR in a candidateBeamRSSCellList; the index of the SSB or the CSI-RS is an index of an entry corresponding to the SSB or the CSI-RS in a candidateBeamRSSCellList.

In one embodiment, the phrase of the first candidate format only can indicate one candidate RS resource for a serving cell at most comprises: the first candidate format only comprises an index of a candidate RS resource for a serving cell at most; the candidate RS resource is an SSB with SS-RSRP higher than rsrp-ThresholdBFR in a candidateBeamRSSCellList, or, the candidate RS resource is a CSI-RS with CSI-RSRP higher than rsrp-ThresholdBFR in a candidateBeamRSSCellList; the index of the candidate RS resource is an index of an entry corresponding to an SSB or a CSI-RS in a candidateBeamRSSCellList.

In one embodiment, a number of BFR information that can indicated by the second candidate format for a serving cell at most is greater than 1.

In one embodiment, the second candidate format is a candidate format in the first candidate format set.

In one embodiment, the second candidate format is any candidate format in the first candidate format set.

In one embodiment, the phrase of a number of candidate RS resources that can be indicated by the second candidate format for a serving cell at most being greater than 1 comprises: the second candidate format can comprise K1 BFR information for a serving cell at most, K1 being a positive integer greater than 1; any of the K1 BFR information is an octet comprising an AC field, the AC field indicates whether there exists a candidate RS ID field, and the candidate RS ID field indicates a candidate RS resource.

In one subembodiment of the above embodiment, the second candidate format comprises the K2 octet(s) for a serving cell, K2 being a non-negative integer not greater than the K1.

In one subembodiment of the above embodiment, the second candidate format comprises K3 candidate RS ID field(s) for a serving cell, K3 being a positive integer not greater than the K2.

In one subembodiment of the above embodiment, the candidate RS ID field indicates an index of an SSB with SS-RSRP higher than rsrp-ThresholdBFR in a candidateBeamRSSCellList, or an index of a CSI-RS with CSI-RSRP higher than rsrp-ThresholdBFR in a candidateBeamRSSCellList; the index of the SSB or the CSI-RS is an index of an entry corresponding to the SSB or the CSI-RS in a candidateBeamRSSCellList.

In one embodiment, the phrase of a maximum number of candidate RS resources that can be indicated by the second candidate format for a serving cell being greater than 1 comprises: the second candidate format can comprise indexes of K1 candidate RS resources at most for a serving cell, K1 being a positive integer greater than 1; any of the K1 candidate RS resources is an SSB with SS-RSRP greater than a threshold or a CSI-RS with CSI-RSRP greater than a threshold in a candidate RS resource list; the index of any of the K1 candidate RS resources is an index of an entry corresponding to an SSB in the candidate RS resource list or an index of an entry corresponding to a CSI-RS in the candidate RS resource list.

In one subembodiment of the above embodiment, the candidate RS resource list is a candidateBeamRSSCellList.

In one subembodiment of the above embodiment, a name of the candidate RS resource list comprises a candidateBeamRSSCellList.

In one subembodiment of the above embodiment, a name of the candidate RS resource list comprises at least one of candidate or Beam or RSS or Cell or List or r17.

In one subembodiment of the above embodiment, the threshold is configured through an RRC field, and a name of the RRC field comprises rsrp-ThresholdBFR.

In one subembodiment of the above embodiment, the threshold is configured through an RRC field, and a name of the RRC field comprises at least one of rsrp or Threshold or BFR or r17.

In one subembodiment of the embodiment, the threshold is rsrp-ThresholdBFR.

In one subembodiment of the embodiment, a name of the threshold comprises rsrp-ThresholdBFR.

In one subembodiment of the embodiment, the threshold is measured by dBm.

In one embodiment, the octet is an octet.

In one embodiment, a length of the octet is equal to 8 bits.

In one embodiment, the K1 candidate RS resources respectively belong to K1 different TRPs.

In one subembodiment of the above embodiment, K2 is equal to 2.

In one subembodiment of the above embodiment, K1 is not greater than 8.

In one embodiment, when the format of the first MAC CE is a candidate format in the first candidate format set, a number of candidate RS resource(s) indicated by the first MAC CE for the first cell is equal to 1.

In one embodiment, when the format of the first MAC CE is a candidate format in the second candidate format set, a number of candidate RS resource(s) indicated by the first MAC CE for the first cell is equal to a maximum number of candidate RS resource(s) that can be indicated by the second candidate format for a serving cell.

In one embodiment, when the format of the first MAC CE is a candidate format in the second candidate format set, a number of candidate RS resource(s) indicated by the first MAC CE for the first cell is not less than 1 and not greater than a maximum number of candidate RS resource(s) that can be indicated by the second candidate format for a serving cell.

In one embodiment, a maximum number of candidate RS resource(s) that can be indicated by the second candidate format for a serving cell is equal to K1.

In one embodiment, a maximum number of candidate RS resource(s) that can be indicated by the second candidate format for a serving cell is equal to 2.

In one embodiment, a candidate RS resource is an RS resource.

In one embodiment, a candidate RS resource is at least one of an SSB or an CSI-RS.

In one embodiment, a candidate RS resource is an SSB; or, a candidate RS resource is a CSI-RS.

In one embodiment, a beam failure for the first RS resource group is detected.

In one embodiment, a beam failure for the second RS resource group is detected.

In one embodiment, a beam failure for the second RS resource group is not detected.

In one embodiment, whether the first condition set comprises a first target condition being related to whether the format of the first MAC CE is related to a candidate format in the first candidate format set or a candidate format in the second candidate format set comprises: if a format of the first MAC CE is a candidate format in the first candidate format set, the first condition set comprises the first target condition.

In one subembodiment of the embodiment, if a format of the first MAC CE is a candidate format in the first candidate format set, and the first cell is an SCell, the first condition set comprises the first target condition.

In one embodiment, whether the first condition set comprises a first target condition is related to whether the first cell is an SCell or a PCell.

In one embodiment, if the first cell is a PCell, the first condition set does not comprise the first target condition.

In one embodiment, if the first cell is an SCell, the first condition set comprises the first target condition.

In one embodiment, whether first condition set comprises a first target condition is related to whether a PUSCH allocated to be occupied by the first MAC CE belongs to the first random access procedure.

In one embodiment, if a PUSCH allocated to be occupied by the first MAC CE belongs to the first random access procedure, the first condition set does not comprise the first target condition.

In one embodiment, if a PUSCH allocated to be occupied by the first MAC CE does not belong to the first random access procedure, the first condition set comprises the first target condition.

In one embodiment, whether the first condition set comprises the first target condition is related to whether the first radio signal belongs to the first random access procedure in the present application.

In one embodiment, whether the first condition set comprises the first target condition is related to a number of candidate RS resource(s) indicated by the first MAC CE for the first cell.

In one embodiment, if a number of candidate RS resources indicated by the first MAC CE for the first cell is greater than 1, the first condition set does not comprise the first target condition.

In one embodiment, if a number of candidate RS resources indicated by the first MAC CE for the first cell is equal to 1, the first condition set does not comprise the first target condition.

In one embodiment, if a number of candidate RS resources indicated by the first MAC CE for the first cell is equal to 1, the first condition set comprises the first target condition.

In one embodiment, whether the first condition set comprises the first target condition is related to whether the second cell is configured.

In one embodiment, whether first condition set comprises the first target condition is related to whether a PUSCH allocated to be occupied by the first MAC CE belongs to any random access procedure.

In one embodiment, whether the first condition set comprises the first target condition is related to whether the first random access procedure is triggered by the first SR.

In one embodiment, whether the first condition set comprises the first target condition is related to whether the first random access procedure is triggered by the first counter reaching the first value and the second counter reaching the second value.

In one embodiment, whether the first condition set comprises a first target condition being related to whether the format of the first MAC CE is related to a candidate format in the first candidate format set or a candidate format in the second candidate format set comprises: if a format of the first MAC CE is a candidate format in the first candidate format set, the first condition set does not comprise the first target condition.

In one subembodiment of the embodiment, if a format of the first MAC CE is a candidate format in the first candidate format set, and the first cell is a PCell, and the first candidate RS resource belongs to the first cell, the first condition set does not comprise the first target condition.

In one subembodiment of the embodiment, if a format of the first MAC CE is a candidate format in the first candidate format set, and the first cell is a PCell, and a second cell is configured, and the first candidate RS resource belongs to the second cell, the first condition set does not comprise the first target condition.

In one embodiment, whether the first condition set comprises a first target condition being related to whether the format of the first MAC CE is related to a candidate format in the first candidate format set or a candidate format in the second candidate format set comprises: if a format of the first MAC CE is a candidate format in the second candidate format set, the first condition set comprises the first target condition.

In one subembodiment of the embodiment, if a format of the first MAC CE is a candidate format in the second candidate format set, and the first cell is an SCell, the first condition set comprises the first target condition.

In one subembodiment of the embodiment, if a format of the first MAC CE is a candidate format in the second candidate format set, and the first cell is a PCell, and a PUSCH allocated to be occupied by the first MAC CE does not belong to any random access procedure, and the first condition set comprises the first target condition.

In one subembodiment of the embodiment, if a format of the first MAC CE is a candidate format in the second candidate format set, and the first cell is a PCell, and a PUSCH allocated to be occupied by the first MAC CE does not belong to the first random access procedure, and the first condition set comprises the first target condition.

In one subembodiment of the embodiment, if a format of the first MAC CE is a candidate format in the second candidate format set, and the first cell is a PCell, and the first MAC CE only indicates a beam failure for the first RS resource group, the first condition set comprises the first target condition.

In one subembodiment of the embodiment, if a format of the first MAC CE is a candidate format in the second candidate format set, and the first cell is a PCell, and a number of candidate RS resource(s) indicated by the first MAC CE for the first cell is equal to 1, the first condition set comprises the first target condition.

In one embodiment, whether the first condition set comprises a first target condition being related to whether the format of the first MAC CE is related to a candidate format in the first candidate format set or a candidate format in the second candidate format set comprises: if a format of the first MAC CE is a candidate format in the second candidate format set, the first condition set does not comprise the first target condition.

In one subembodiment of the embodiment, if a format of the first MAC CE is a candidate format in the second candidate format set, and the first cell is a PCell, and a PUSCH allocated to be occupied by the first MAC CE belongs to the first random access procedure, the first condition set does not comprise the first target condition.

In one subembodiment of the embodiment, if a format of the first MAC CE is a candidate format in the second candidate format set, and the first cell is a PCell, and the first random access procedure is triggered by the first counter reaching the first value and the second counter reaching the second value, and a PUSCH allocated to be occupied by the first MAC CE belongs to the first random access procedure, the first condition set does not comprise the first target condition.

In one subembodiment of the embodiment, if a format of the first MAC CE is a candidate format in the second candidate format set, and the first cell is a PCell, and a PUSCH allocated to be occupied by the first MAC CE belongs to the first random access procedure, and the first random access procedure is triggered by the first counter reaching the first value and the second counter reaching the second value, the first condition set does not comprise the first target condition.

In one subembodiment of the embodiment, if a format of the first MAC CE is a candidate format in the second candidate format set, and the first cell is a PCell, and a PUSCH allocated to be occupied by the first MAC CE belongs to the first random access procedure, and the first random access procedure is triggered by the first SR, the first condition set does not comprise the first target condition.

In one subembodiment of the embodiment, if a format of the first MAC CE is a candidate format in the second candidate format set, and the first cell is a PCell, and the first MAC CE indicates a beam failure for the first RS resource group and a beam failure for the second RS resource group, the first condition set does not comprise the first target condition.

In one subembodiment of the embodiment, if a format of the first MAC CE is a candidate format in the second candidate format set, and the first cell is a PCell, and a number of candidate RS resources indicated by the first MAC CE for the first cell is greater than 1, the first condition set does not comprise the first target condition.

In one subembodiment of the embodiment, if a format of the first MAC CE is a candidate format in the second candidate format set, and the first cell is a PCell, and a number of candidate RS resource(s) indicated by the first MAC CE for the first cell is equal to 1, the first condition set does not comprise the first target condition.

In one embodiment, the phrase of whether the first condition set comprises a first target condition being related to whether the format of the first MAC CE is a candidate format in the first candidate format set or a candidate format in the second candidate format set comprises: if the format of the first MAC CE is a candidate format in the first candidate format set, the first condition set comprises the first target condition; if the format of the first MAC CE is a candidate format in the second candidate format set, the first condition set does not comprise the first target condition.

In one embodiment, the phrase of whether the first condition set comprises a first target condition being related to whether the format of the first MAC CE is a candidate format in the first candidate format set or a candidate format in the second candidate format set comprises: if the format of the first MAC CE is a candidate format in the first candidate format set, the first condition set does not comprise the first target condition; if the format of the first MAC CE is a candidate format in the second candidate format set, the first condition set does not comprise the first target condition.

In one embodiment, the second cell is a candidate cell used for L1/L2 mobility configured for the first cell.

In one embodiment, a transmitter of the first signaling is a maintenance base station of the second cell.

In one embodiment, the first signaling is transmitted on the second cell.

In one embodiment, the second cell provides extra physical resources on the second cell.

In one embodiment, the first cell and the second cell are of a same frequency.

In one embodiment, the first cell and the second cell are of different frequencies.

In one embodiment, a Physical Cell Identifier (PCI) of the first cell is different from a PCI of the second cell.

In one embodiment, the first cell is configured a ServCellIndex and the second cell is not configured a ServCellIndex.

In one embodiment, the PCell refers to an SpCell, the SpCell is a PCell or a Primary SCG Cell (PSCell).

In one embodiment, the SCell refers to an SCell.

### Embodiment 2

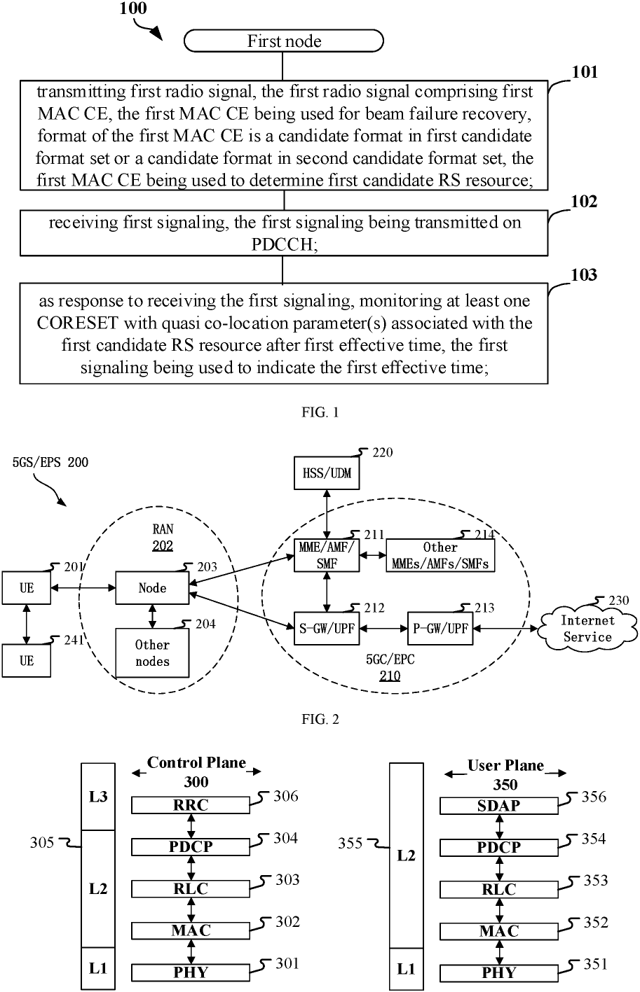

Embodiment 2 illustrates a schematic diagram of a network architecture according to one embodiment of the present application, as shown in FIG. 2. FIG. 2 is a diagram illustrating a network architecture 200 of 5G NR/ Long-Term Evolution (LTE)/ Long-Term Evolution Advanced (LTE-A) systems. The 5G NR/ LTE/ LTE-A network architecture 200 may be called a 5G System (5GS)/Evolved Packet System (EPS) 200 or other appropriate terms. The 5GS/EPS 200 comprises at least one of a UE 201, an RAN 202, a 5G Core Network/Evolved Packet Core (5GC/EPC) 210, a Home Subscriber Server (HSS)/ Unified Data Management (UDM) 220 or an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The RAN comprises the node 203 and other nodes 204. The node 203 provides UE 201-oriented user plane and control plane protocol terminations. The node 203 may be connected to other nodes 204 via an Xn interface (e.g., backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (loT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an S1/NG interface. The 5GC/EPC 210 comprises a Mobility Management Entity (MME)/ Authentication Management Field (AMF)/ Session Management Function (SMF) 211, other MMEs/ AMFs/ SMFs 214, a Service Gateway (S-GW)/ User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 is a User Equipment (UE).

In one embodiment, the node 203 corresponds to the second node in the present application.

In one embodiment, the node 203 is a BaseStation (BS).

In one embodiment, the node 203 is a UE.

In one embodiment, the node 203 is a relay.

In one embodiment, the node 203 is a gateway.

In one embodiment, the node 204 corresponds to the third node in the present application.

In one embodiment, the node 204 corresponds to the fourth node in the present application.

In one embodiment, the node 204 is a base station.

In one embodiment, the node 204 is a UE.

In one embodiment, the node 204 is a relay.

In one embodiment, the node 204 is a gateway.

In one embodiment, the UE supports Terrestrial Network (NTN) transmission.

In one embodiment, the UE supports Non-Terrestrial Network (NTN) transmission.

In one embodiment, the UE supports transmission within networks with large latency differences.

In one embodiment, the UE supports Dual Connection (DC) transmission.

In one embodiment, the UE comprises a mobile terminal, or the UE comprises an aircraft, or the UE comprises an on-board terminal, or the UE comprises a ship, or the UE comprises an Internet of Things terminal, or the UE comprises an Industrial Internet of Things terminal, or the UE comprises an equipment supporting low latency and high reliability transmission, or the UE comprises testing equipment, or the UE comprises a signaling tester.

In one embodiment, the base station is a BS, or the base station is a Base Transceiver Station (BTS), or the base station is a NodeB (NB), or the base station is a gNB, or the base station is an eNB, or the base station is an ng-eNB, or the base station is an en-gNB.

In one embodiment, the base station comprises test equipment, or the base station comprises a signaling tester, or the base station comprises satellite equipment, or the base station comprises flight platform equipment, or the base station comprises a Marco Cellular base station, or the base station comprises a Micro Cell base station, or the base station comprises a Pico Cell base station, or the base station comprises a Femtocell.

In one embodiment, the base station supports transmission within a non-terrestrial network.

In one embodiment, the base station supports transmission within networks with large latency differences.

In one embodiment, the base station supports transmission within terrestrial networks.

In one embodiment, the base station comprises a base station supporting large latency differences.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises an Integrated Access and Backhaul (IAB)-node.

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises an L3 relay.

In one embodiment, the relay comprises an L2 relay.

In one embodiment, the relay comprises a router.

In one embodiment, the relay comprises a switch.

In one embodiment, the relay comprises a UE.

In one embodiment, the relay comprises a base station.

### Embodiment 3

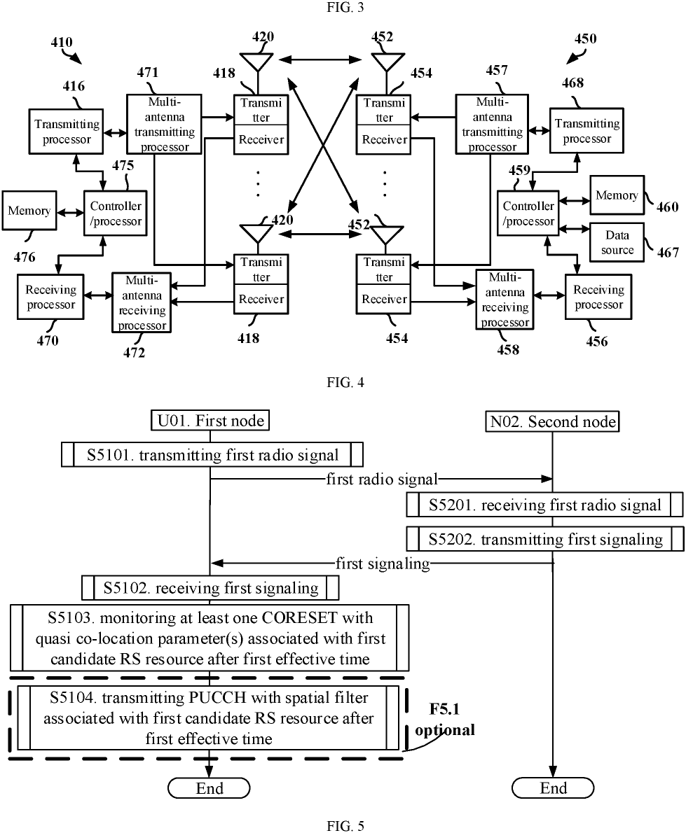

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 is represented by three layers, which are a layer 1, a layer 2 and a layer 3, respectively. The layer 1 (L1) is the lowest layer and performs signal processing functions of various PHY layers. The L1 is called PHY 301 in the present application. L2 305, above the PHY 301, comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a data packet and provides support for handover. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating various radio resources (i.e., resources block) in a cell. The MAC sublayer 302 is also in charge of HARQ operation. The RRC sublayer 306 in L3 layer of the control plane 300 is responsible for acquiring radio resources (i.e., radio bearer) and configuring the lower layer with an RRC signaling. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic.

In one embodiment, the radio protocol architecture in FIG. 3 is applicable to the first node in the present application.

In one embodiment, the radio protocol architecture in FIG. 3 is applicable to the second node in the present application.

In one embodiment, the first MAC CE in the present application is generated by the MAC 302 or the MAC 352.

In one embodiment, the first radio signal in the present application is generated by the RRC 306.

In one embodiment, the first radio signal in the present application is generated by the MAC 302 or the MAC 352.

In one embodiment, the first radio signal in the present application is generated by the PHY 301 or the PHY 351.

In one embodiment, the first signaling in the present application is generated by the RRC 306.

In one embodiment, the first signaling in the present application is generated by the MAC 302 or the MAC 352.

In one embodiment, the first signaling in the present application is generated by the PHY 301 or the PHY 351.

In one embodiment, the first message in the present application is generated by the RRC 306.

In one embodiment, the first message in the present application is generated by the MAC 302 or the MAC 352.

In one embodiment, the first message in the present application is generated by the PHY 301 or the PHY 351.

In one embodiment, the first random access preamble in the present application is generated by the PHY 301 or the PHY 351.

In one embodiment, the PDCCH in the present application is generated by the PHY 301 or the PHY 351.

In one embodiment, the first SR in the present application is triggered at the PHY 301 or the PHY 351.

In one embodiment, the first BFR in the present application is triggered at the PHY 301 or the PHY 351.

In one embodiment, the first target signaling in the present application is generated by the RRC 306.

In one embodiment, the first target signaling in the present application is generated by the MAC 302 or the MAC 352.

In one embodiment, the first target signaling in the present application is generated by the PHY 301 or the PHY 351.

In one embodiment, the second target signaling in the present application is generated by the RRC 306.

In one embodiment, the second target signaling in the present application is generated by the MAC 302 or the MAC 352.

In one embodiment, the second target signaling in the present application is generated by the PHY 301 or the PHY 351.

### Embodiment 4

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/ processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/ processor 475, a memory 476, a receiving processor 470, a transmitting processor 416, a multi-antenna receiving processor 472, a multi-antenna transmitting processor 471, a transmitter/ receiver 418 and an antenna 420.

In a transmission from the second communication device 410 to the first communication device 450, at the first communication device 410, a higher layer packet from the core network is provided to a controller/ processor 475. The controller/processor 475 provides a function of the L2 layer. In the transmission from the second communication device 410 to the first communication device 450, the controller/ processor 475 provides header compression, encryption, packet segmentation and reordering, and multiplexing between a logical channel and a transport channel, and radio resources allocation for the first communication device 450 based on various priorities. The controller/ processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/ beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/ processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises at least one processor and at least one memory. at least one processor and at least one memory. The at least one memory comprises computer program codes; the at least one memory and the computer program codes are configured to be used in collaboration with the at least one processor, the first communication device 450 at least: transmits a first radio signal, the first radio signal comprises a first MAC CE, the first MAC CE is used for a BFR, a format of the first MAC CE is a candidate format in a first candidate format set or a candidate format in a second candidate format set, the first MAC CE is used to determine a first candidate RS resource; receives a first signaling, the first signaling is transmitted on a PDCCH; as a response to receiving the first signaling, monitors at least one CORESET with QCL parameter(s) associated with the first candidate RS resource after a first effective time, the first signaling is used to indicate the first effective time; herein, the first signaling satisfies all conditions in a first condition set; one condition comprised in the first condition set is that the first signaling is identified by a first RNTI, and the first RNTI is allocated to the first node; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.

In one embodiment, the first communication device 450 comprises at least one processor and at least one memory. a memory that stores a computer readable instruction program. The computer readable instruction program generates an action when executed by at least one processor. The action includes: transmitting a first radio signal, the first radio signal comprising a first MAC CE, the first MAC CE being used for a BFR, a format of the first MAC CE being a candidate format in a first candidate format set or a candidate format in a second candidate format set, the first MAC CE being used to determine a first candidate RS resource; receiving a first signaling, the first signaling being transmitted on a PDCCH; as a response to receiving the first signaling, monitoring at least one CORESET with QCL parameter(s) associated with the first candidate RS resource after a first effective time, the first signaling being used to indicate the first effective time; herein, the first signaling satisfies all conditions in a first condition set; one condition comprised in the first condition set is that the first signaling is identified by a first RNTI, and the first RNTI is allocated to the first node; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: receives a first radio signal, the first radio signal comprises a first MAC CE, the first MAC CE is used for a BFR, a format of the first MAC CE is a candidate format in a first candidate format set or a candidate format in a second candidate format set, the first MAC CE is used to determine a first candidate RS resource; transmits a first signaling, the first signaling is transmitted on a PDCCH; herein, as a response to the first signaling being received by a transmitter of the first radio signal, a transmitter of the first radio signal monitors at least one CORESET with QCL parameter(s) associated with the first candidate RS resource after a first effective time, the first signaling is used to indicate the first effective time; the first signaling satisfies all conditions in a first condition set; one condition comprised in the first condition set is that the first signaling is identified by a first RNTI, and the first RNTI is allocated to a transmitter of the first radio signal; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.

In one embodiment, the second communication device 410 comprises a memory that stores a computer readable instruction program. The computer readable instruction program generates an action when executed by at least one processor. The action includes: receiving a first radio signal, the first radio signal comprising a first MAC CE, the first MAC CE being used for a BFR, a format of the first MAC CE being a candidate format in a first candidate format set or a candidate format in a second candidate format set, the first MAC CE being used to determine a first candidate RS resource; transmitting a first signaling, the first signaling being transmitted on a PDCCH; herein, as a response to the first signaling being received by a transmitter of the first radio signal, a transmitter of the first radio signal monitors at least one CORESET with QCL parameter(s) associated with the first candidate RS resource after a first effective time, the first signaling is used to indicate the first effective time; the first signaling satisfies all conditions in a first condition set; one condition comprised in the first condition set is that the first signaling is identified by a first RNTI, and the first RNTI is allocated to a transmitter of the first radio signal; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.

In one embodiment, the antenna 452, the transmitter 454, the transmitting processor 468, and the controller/processor 459 are used to transmit a first radio signal; at least one of the antenna 420, the receiver 418, the receiving processor 470, or the controller/processor 475 is used to receive a first radio signal.

In one embodiment, the antenna 452, the receiver 454, the receiving processor 456, the controller/processor 459 are used to receive a first signaling; at least one of the antenna 420, the transmitter 418, the transmitting processor 416, or the controller/processor 475 is used to transmit the first signaling.

In one embodiment, the antenna 452, the receiver 454, the receiving processor 456, the controller/processor 459 are used to receive a first target signaling; at least one of the antenna 420, the transmitter 418, the transmitting processor 416, or the controller/processor 475 is used to transmit a first target signaling.

In one embodiment, the antenna 452, the receiver 454, the receiving processor 456, the controller/processor 459 are used to receive a first target signaling; at least one of the antenna 420, the transmitter 418, the transmitting processor 416, or the controller/processor 475 is used to transmit a first target signaling.

In one embodiment, the antenna 452, the receiver 454, the receiving processor 456, and the controller/processor 459 are used to receive a first message; at least one of the antenna 420, the transmitter 418, the transmitting processor 416, or the controller/processor 475 is used to transmit a first message.

In one embodiment, the antenna 452, the transmitter 454, the transmitting processor 468, and the controller/processor 459 are used to transmit a PUCCH; at least one of the antenna 420, the receiver 418, the receiving processor 470, or the controller/processor 475 is used to receive a PUCCH.

In one embodiment, the antenna 452, the transmitter 454, the transmitting processor 468, and the controller/processor 459 are used to transmit a first random access preamble; at least one of the antenna 420, the receiver 418, the receiving processor 470, or the controller/processor 475 is used to receive a first random access preamble.

In one embodiment, the first communication device 450 corresponds to a first node in the present application.

In one embodiment, the second communication device 410 corresponds to a second node in the present application.

### Embodiment 5

Embodiment 5 illustrates a flowchart of radio signal transmission according to one embodiment in the present application, as shown in FIG. 5. It is particularly underlined that the order illustrated in the embodiment does not put constraints over sequences of signal transmissions and implementations.

The first node U01 transmits a first radio signal in step S5101, the first radio signal comprises a first MAC CE, the first MAC CE is used for a BFR, a format of the first MAC CE is a candidate format in a first candidate format set or a candidate format in a second candidate format set, the first MAC CE is used to determine a first candidate RS resource; in step S5102, receives a first signaling, the first signaling is transmitted on a PDCCH; in step S5103, as a response to receiving the first signaling, monitors at least one CORESET with QCL parameter(s) associated with the first candidate RS resource after a first effective time, the first signaling is used to indicate the first effective time; in step S5104, as a response to receiving the first signaling, adopts a spatial filter associated with the first candidate RS resource to transmit a PUCCH after the first effective time.

The second node N02 receives the first radio signal in step S5201; transmits the first signaling in step S5202.

In embodiment 5, the first signaling satisfies all conditions in a first condition set; one condition comprised in the first condition set is that the first signaling is identified by a first RNTI, and the first RNTI is allocated to the first node; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.

In one embodiment, the first node U01 is a UE.

In one embodiment, the first node U01 is a base station.

In one embodiment, the second node N02 is a UE.

In one embodiment, the second node N02 is a base station.

In one embodiment, the second node N02 is an MN of the first node U01.

In one embodiment, the second node N02 is an SN of the first node U01.

In one embodiment, the second node N02 comprises at least two TRPs.

In one embodiment, the second node N02 is a maintenance base station of the first cell.

In one embodiment, the second node N02 is a base station, and the first node U01 is a UE.

In one embodiment, the second node N02 is a base station, and the first node U01 is a base station.

In one embodiment, the second node N02 is a UE, and the first node U01 is a UE.

In one embodiment, the spatial filer is spatial filter.

In one embodiment, for the meaning of the spatial filter, refer to TS 38.213.

In one embodiment, a spatial filter associated with the first candidate RS resource comprises a spatial filter corresponding to the first candidate RS resource and used for a periodic CSI-RS or SS/PBCH block reception.

In one embodiment, the PUCCH is transmitted on the first cell.

In one embodiment, the PUCCH is transmitted on a TRP to which the first RS resource group belongs.

In one embodiment, as a response to receiving the first signaling, if PUCCH resources are configured for a TRP to which the first RS resource group belongs, a spatial filter associated with the first candidate RS resource is adopted to transmit a PUCCH after the first effective time.

In one embodiment, for a periodic CSI-RS or SSB reception, as a response to receiving the first signaling, if PUCCH resources are configured for a TRP to which the first RS resource group belongs, a spatial filter associated with the first candidate RS resource is adopted to transmit a PUCCH after the first effective time.

In one embodiment, the PUCCH is transmitted.

In one embodiment, the PUCCH is not transmitted.

In one embodiment, the first node U01 is configured with spatial relation information for the PUCCH.

In one embodiment, the PUCCH spatial relation information comprises PUCCH-SpatialRelationInfo.

In one embodiment, the PUCCH spatial relation information is configured through PUCCH-SpatialRelationInfo.

In one embodiment, a PUCCH with a Link Recovery Request (LRR) is not transmitted in the first cell.

In one embodiment, a PUCCH with an LRR is not transmitted on a TRP to which the second RS resource group in the first cell belongs.

In one embodiment, a PUCCH with an LRR is not transmitted in the first cell or is not transmitted on a TRP to which the second RS resource group in the first cell belongs.

In one embodiment, if a PUCCH with an LRR is not transmitted in the first cell or is not transmitted on a TRP to which the second RS resource group in the first cell belongs, and the first node U01 is configured with PUCCH spatial relation information for the PUCCH, a spatial filter associated with the first candidate RS resource is adopted after the first effective time to transmit a PUCCH on a TRP to which the first RS resource group belongs.

In one embodiment, the box F5.1 framed with dotted lines is optional.

In one embodiment, the box F5.1 framed with dotted lines exists.

In one embodiment, the box F5.1 framed with dotted lines does not exist.

### Embodiment 6

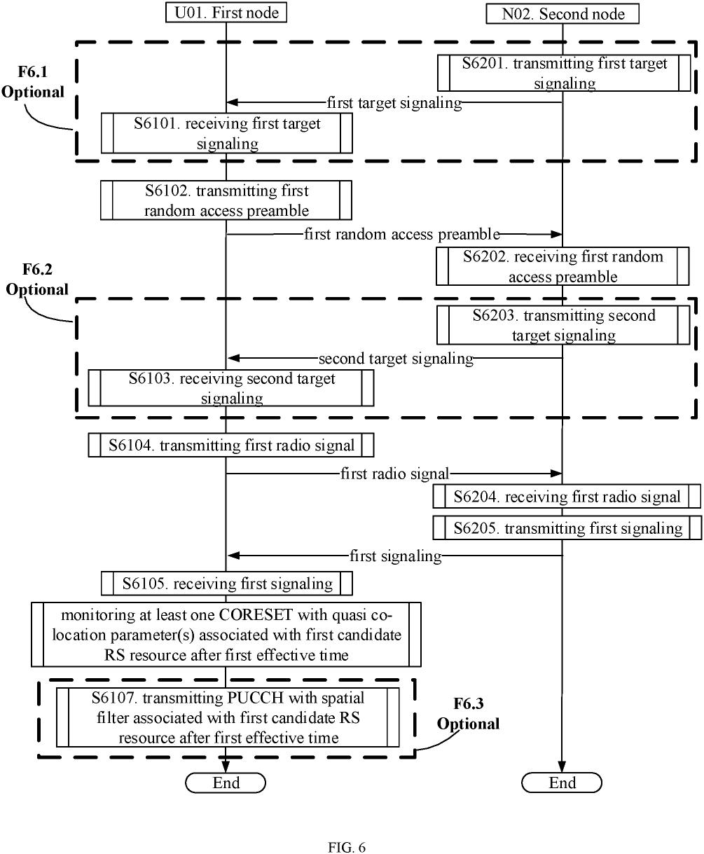

Embodiment 6 illustrates a flowchart of radio signal transmission according to another embodiment of the present application, as shown in FIG. 6. It is particularly underlined that the order illustrated in the embodiment does not put constraints over sequences of signal transmissions and implementations.

The first node U01 in step S6101 receives a first target signaling, the first target signaling is used to determine that the first random access preamble is associated with the first uplink grant; in step S6102, transmits a first random access preamble in a first random access procedure, the first random access preamble is used to determine a first uplink grant; in step S6103, receives a second target signaling, the second target signaling indicates the first uplink grant; in step S6104, transmits a first radio signal, the first radio signal comprises a first MAC CE, the first MAC CE is used for a BFR, a format of the first MAC CE is a candidate format in a first candidate format set or a candidate format in a second candidate format set, the first MAC CE is used to determine a first candidate RS resource; in step S6105, receives a first signaling, the first signaling is transmitted on a PDCCH; in step S6106, as a response to receiving the first signaling, monitors at least one CORESET with QCL parameter(s) associated with the first candidate RS resource after a first effective time, the first signaling is used to indicate the first effective time; in step S6107, as a response to receiving the first signaling, adopts a spatial filter associated with the first candidate RS resource to transmit a PUCCH after the first effective time.

The second node N02 transmits the first target signaling in step S6201; in step S6202, receives the first random access preamble; in step S6203, transmits the second target signaling; in step S6204, receives the first radio signal; in step S6205, transmits the first signaling.

In embodiment 6, the first signaling satisfies all conditions in a first condition set; one condition comprised in the first condition set is that the first signaling is identified by a first RNTI, and the first RNTI is allocated to the first node U01; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1; the first uplink grant is used to carry the first radio signal; the first signaling is used to determine that the first random access procedure is successfully completed; when the format of the first MAC CE is a candidate format in the second candidate format set, one condition comprised in the first condition set is that the first signaling is used to determine that the first random access procedure is successfully completed.

In one embodiment, the first cell is a PCell.

In one embodiment, the first condition set does not comprise a first target condition.

In one embodiment, the format of the first MAC CE is a candidate format in the first candidate format set, the first condition set does not comprise a first target condition, and one condition comprised in the first condition set is that the first signaling is used to determine that the first random access procedure is successfully completed.

In one embodiment, the format of the first MAC CE is a candidate format in the second candidate format set, the first condition set does not comprise a first target condition, and one condition comprised in the first condition set is that the first signaling is used to determine that the first random access procedure is successfully completed.

In one embodiment, the behavior of generating the first MAC CE in the first random access procedure comprises indicating that Multiplexing and assembly entity comprises the first MAC CE in a continuous uplink transmission in the first random access procedure.

In one embodiment, before the first random access procedure is initiated, the first MAC CE is not generated.

In one embodiment, the behavior of generating the first MAC CE comprises assembling the first MAC CE.

In one embodiment, the behavior of generating the first MAC CE comprises setting a value of a field in the first MAC CE.

In one embodiment, the first candidate RS resource and the first random access preamble are associated with two different TRPs of the first cell.

In one embodiment, the first candidate RS resource and the first random access preamble are associated with a same TRP of the first cell.

In one embodiment, the first radio signal is an Msg3.

In one embodiment, the first radio signal is an MsgA.

In one embodiment, the first target signaling is an RRC message.

In one embodiment, the first target signaling is a downlink message.

In one embodiment, the first target signaling is a sidelink message.

In one embodiment, the first target signaling is an RRCReconfiguration message.

In one embodiment, the first target signaling is an RRCReconfigurationSidelink message.

In one embodiment, the first target signaling comprises an RRC IE, and a name of the RRC IE comprises CellGroupConfig.

In one embodiment, the first target signaling comprises an RRC IE, and a name of the RRC IE comprises ServingCellConfig.

In one embodiment, the first target signaling comprises an RRC IE, and a name of the RRC IE comprises BWP-UplinkCommon.

In one embodiment, the first target signaling comprises an RRC IE, and a name of the RRC IE comprises MsgA-ConfigCommon.

In one embodiment, the first target signaling comprises an RRC IE, and a name of the RRC IE comprises MsgA-PUSCH-Config.

In one embodiment, the first target signaling comprises an RRC IE, and a name of the RRC IE comprises RACH-ConfigCommonTwoStepRA.

In one embodiment, the first target signaling comprises an RRC field, and a name of the RRC field comprises MsgA-PUSCH-Resource.

In one embodiment, the first target signaling comprises an RRC IE whose name comprises RACH-ConfigCommonTwoStepRA being used to determine the first random access preamble, and the first target signaling comprises an RRC IE whose name comprises MsgA-PUSCH-Resource being used to determine the first uplink grant.

In one embodiment, the first target signaling is used to determine at least one random access preamble corresponding to an MSGA, and PUSCH resources associated with any random access preamble in the at least one random access preamble.

In one embodiment, a time when the first target signaling is received is earlier than a time when the first random access preamble is transmitted.

In one embodiment, a time when the first target signaling is received is earlier than a time when the first random access procedure is initiated.

In one embodiment, as a response to the first random access preamble being transmitted, the first uplink grant is determined according to the first target signaling.

In one embodiment, the phrase of the first random access preamble being used to determine a first uplink grant comprises: the first target signaling is used to determine the first uplink grant; the first target signaling is used to determine that the first random access preamble is associated with the first uplink grant.

In one embodiment, the phrase of the first random access preamble being used to determine a first uplink grant comprises: the first uplink grant is selected according to the first random access preamble.

In one embodiment, the phrase of the first random access preamble being used to determine a first uplink grant comprises selecting a PUSCH occasion out of PUSCH occasions corresponding to PRACH slots of PRACH occasions corresponding to the first random access preamble, determining the first uplink grant in the PUSCH occasion.

In one embodiment, accompanying the first random access preamble, the first radio signal is transmitted.

In one embodiment, the first radio signal is transmitted on PUSCH resources of an MSGA associated with the first random access preamble.

In one embodiment, the second target signaling is used for a new data transmission.

In one embodiment, the second target signaling is used for a retransmission.

In one embodiment, a time when the second target signaling is received is later than a time when the first random access preamble is transmitted.

In one embodiment, the second signaling is a PDCCH transmission addressed to a TC-RNTI.

In one embodiment, the second target signaling is a MAC layer signaling.

In one embodiment, the second target signaling is a MAC PDU.

In one embodiment, the second target signaling is an MSGB.

In one embodiment, the second target signaling is a Random Access Response.

In one embodiment, the second target signaling is a MAC RAR.

In one embodiment, the second target signaling comprises a fallbackRAR.

In one embodiment, the second target signaling comprises a MAC payload of an RAR.

In one embodiment, the second target signaling comprises a MAC payload of an MSGB.

In one embodiment, the second target signaling comprises a MAC RAR.

In one embodiment, the second target signaling comprises a fallbackRAR.

In one embodiment, the second target signaling comprises at least one MAC sub-header.

In one embodiment, the second target signaling comprises at least one MAC PDU.

In one embodiment, the target signaling comprises a field, and the field indicates the first uplink grant.

Typically, the field is a UL Grant field, and a size of the UL Grant is 27 bits.

In one embodiment, the phrase of the first random access preamble being used to determine a first uplink grant comprises: the second target signaling is used to determine the first uplink grant; the first random access preamble triggers the first target signaling.

In one embodiment, the phrase of the first random access preamble being used to determine a first uplink grant comprises: the second target signaling is used to indicate the first uplink grant; the first random access preamble triggers the first target signaling.

In one embodiment, the phrase of the first random access preamble being used to determine a first uplink grant comprises: the second target signaling is triggered by the first random access preamble is used to determine the first uplink grant.

In one embodiment, as a response to the second target signaling being received, the first radio signal is transmitted.

In one embodiment, the first random access procedure is related to BFR.

In one embodiment, the first random access procedure is used for a BFR.

In one embodiment, the first random access procedure is used for a resource request.

In one embodiment, the first random access procedure is triggered by an SR.

In one embodiment, the first random access procedure is triggered by a BFR.

In one embodiment, the first random access preamble is a last random preamble in the first random access procedure.

In one embodiment, the first random access preamble is any random preamble in the first random access procedure.

In one embodiment, the first random access preamble is a random access preamble corresponding to a time when the first random access procedure is determined successfully completed.

In one embodiment, the first random access preamble is associated with an SSB.

In one embodiment, the first random access preamble is associated with a CSI-RS.

In one embodiment, the first random access preamble is used for a 2-stepRA.

In one embodiment, the first random access preamble is used for a 4-stepRA.

In one embodiment, the first random access preamble is used for a Competition-Based RA (CBRA).

In one embodiment, the phrase of the first uplink grant being used to carry the first radio signal comprises indicating a physical layer to generate a transmission for the first radio signal according to the first uplink grant.

In one embodiment, the phrase of the first uplink grant being used to carry the first radio signal comprises: uplink resources used to transmit the first radio signal are the first uplink grant.

In one embodiment, the phrase of the first uplink grant being used to carry the first radio signal comprises: the first radio signal being transmitted on time-frequency resources correspond to the first uplink grant.

In one embodiment, the phrase of the first uplink grant being used to carry the first radio signal comprises: the first radio signal is transmitted according to scheduling information indicated according to the first uplink grant.

In one embodiment, the phrase of the first uplink grant being used to carry the first radio signal comprises: the first uplink grant comprises a PUSCH allocated to be occupied by the first radio signal.

In one embodiment, the phrase of the first uplink grant being used to carry the first radio signal comprises: the first uplink grant comprises a PUSCH allocated to be occupied by the first MAC CE.

In one embodiment, as a response to the first radio signal being transmitted, ra-ContentionResolutionTimer is started.

In one embodiment, as a response to each time the first radio signal is retransmitted by a HARQ, ra-ContentionResolutionTimer is restarted.

In one embodiment, as a response to the first radio signal being transmitted, ra-ContentionResolutionTimer is started at a first symbol after the first radio signal ends, and as a response to each first radio signal is retransmitted by a HARQ, ra-ContentionResolutionTimer is restarted at a first symbol after the first radio signal ends.

In one embodiment, the first radio signal comprises a C-RNTI MAC CE, and the C-RNTI MAC CE comprises the first RNTI.

In one embodiment, the phrase of the first signaling being used to determine the first random access procedure being successfully completed comprises: an indication of a reception of the first signaling from a lower layer being received at the MAC layer is used to determine that the first random access procedure is successfully completed.

In one embodiment, the phrase of the first signaling being used to determine the first random access procedure being successfully completed comprises: in a running period of ra-ContentionResolutionTimer, if a notification of a reception of the first signaling from a lower layer is received, and the first signaling is identified by a first RNTI, and the first radio signal comprises a C-RNTI MAC CE, it is assumed that the first random access procedure is successfully completed.

In one embodiment, as a response to the first random access preamble being transmitted, msgB-ResponseWindow is started.

In one embodiment, the phrase of the first signaling being used to determine that the first random access procedure is successfully completed comprises: in a running period of msgB-ResponseWindow, if a notification of a reception of the first signaling from a lower layer is received, and the first signaling is identified by a first RNTI, and the first radio signal comprises a C-RNTI MAC CE, it is assumed that the first random access procedure is successfully completed.

In one embodiment, when the format of the first MAC CE is a candidate format in the first candidate format set, one condition comprised in the first condition set is that the first signaling is used to determine that the first random access procedure is successfully completed.

In one embodiment, if the first condition set comprises the first target condition, the first condition set does not comprise that the first signaling is used to determine that the first random access procedure is successfully completed.

In one embodiment, if the first condition set does not comprise the first target condition, the first condition set comprises that the first signaling is used to determine that the first random access procedure is successfully completed.

In one embodiment, a PDCCU used for carrying the first signaling has same antenna port QCL properties with an SSB associated to the first random access preamble.

In one embodiment, a PDCCU used for carrying the first signaling has same antenna port QCL properties with the first candidate RS resource.

In one embodiment, the box F6.1 framed with dotted lines is optional.

In one embodiment, the box F6.1 framed with dotted lines exists.

In one embodiment, the box F6.1 framed with dotted lines does not exist.

In one embodiment, the box F6.2 framed with dotted lines is optional.

In one embodiment, the box F6.2 framed with dotted lines exists.

In one embodiment, the box F6.2 framed with dotted lines does not exist.

In one embodiment, the box F6.3 framed with dotted lines is optional.

In one embodiment, the box F6.3 framed with dotted lines exists.

In one embodiment, the box F6.3 framed with dotted lines does not exist.

In one embodiment, the boxes F6.1 and F6.2 framed with dotted lines exist at the same time.

In one embodiment, the box F6.1 framed with dotted lines exists, and the box F6.2 framed with dotted lines does not exist.

In one embodiment, the box F6.1 framed with dotted lines does not exist, and the box F6.2 framed with dotted lines exists.

### Embodiment 7

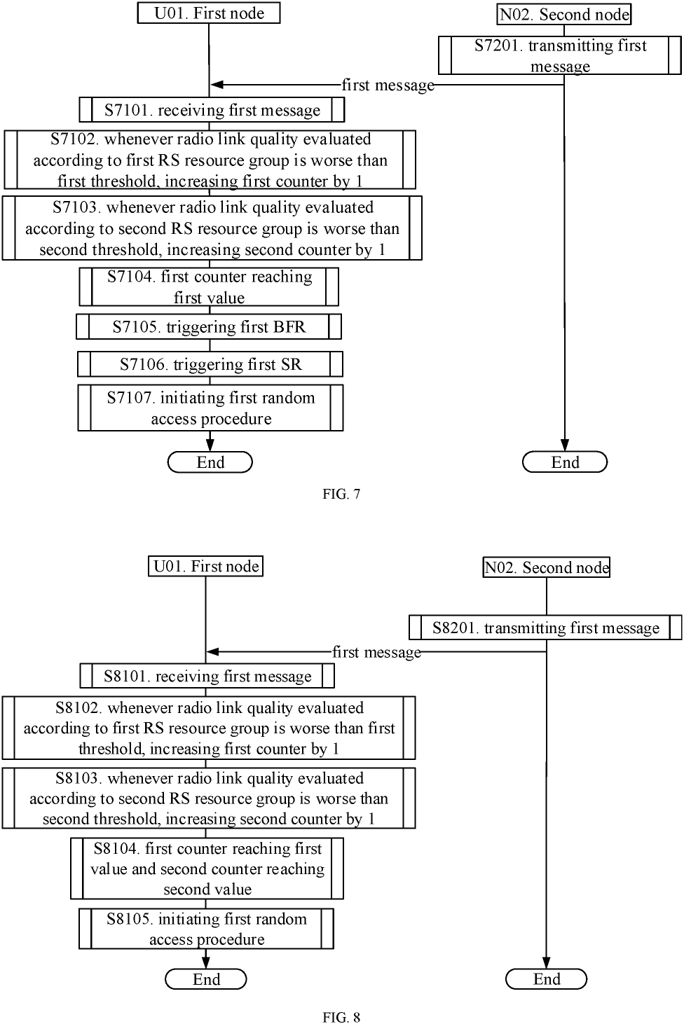

Embodiment 7 illustrates a flowchart of radio signal transmission according to another embodiment in the present application, as shown in FIG. 7. It is particularly underlined that the order illustrated in the embodiment does not put constraints over sequences of signal transmissions and implementations.

The first node U01, in step S7101, receives a first message, the first message indicates at least a first RS resource group and a second RS resource group, the first RS resource group comprises at least one RS resource, and the second RS resource group comprises at least one RS resource; in step S7102, whenever radio link quality evaluated according to the first RS resource group is worse than a first threshold, increases a first counter by 1; in step S7103, whenever radio link quality evaluated according to the second RS resource group is worse than a second threshold, increases a second counter by 1; in step S7104, the first counter reaches the first value; in step S7105, as a response to the first counter reaching the first value, triggers a first BFR; in step S7106, as a response to the first BFR being triggered, triggers a first SR; in step S7107, as a response to the first SR being triggered, initiates the first random access procedure.

The second node N02, in step S7201, transmits the first message.

In embodiment 7, the first signaling satisfies all conditions in a first condition set; one condition comprised in the first condition set is that the first signaling is identified by a first RNTI, and the first RNTI is allocated to the first node U01; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1; the first RS resource group and the second RS resource group belong to a same serving cell; the first candidate RS resource is associated with the first RS resource group; at least a former of the first counter reaching a first value or the second counter reaching a second value is used to determine to initiate the first random access procedure; the first threshold and the second threshold are configurable; the first value and the second value are configurable, and the first value and the second value are respectively a positive integer.

In one embodiment, a transmitter of the first message is a maintenance base station of a first cell.

In one embodiment, a transmitter of the first message is a maintenance base station of a serving cell other than the first cell among all serving cells of the first node U01.

In one embodiment, the first message is used to configure the first RS resource group.

In one embodiment, the first message implicitly indicates the first RS resource group.

In one embodiment, the first message explicitly indicates the first RS resource group.

In one embodiment, the first message is used to configure the second RS resource group.

In one embodiment, the first message implicitly indicates the second RS resource group.

In one embodiment, the first message explicitly indicates the second RS resource group.

In one embodiment, the first message is used to determine an index of each RS resource in the first RS resource group.

In one embodiment, the first message is used to determine an index of each RS resource in the second RS resource group.

In one embodiment, the first message comprises a Downlink signaling.

In one embodiment, the first message comprises a sidelink signaling.

In one embodiment, the first message is an RRC message.

In one embodiment, the first message comprises at least one RRC message.

In one embodiment, the first message comprises at least one IE in an RRC message.

In one embodiment, the first message comprises at least one field in an RRC message.

In one embodiment, the first message comprises an RRCReconfiguration message.

In one embodiment, the first message comprises a System Information Block 1 (SIB 1) message.

In one embodiment, the first message comprises a SystemInformation message.

In one embodiment, the first message is a field or an IE other than an IE RadioLinkMonitoringConfig.

In one embodiment, the first message comprises at least one IE other than an IE RadioLinkMonitoringConfig.

In one embodiment, the first message comprises M sub-signaling(s), and each sub-signaling comprises an IE RadioLinkMonitoringConfig, M being a number of Bandwidth Part(s) (BWP(s)).

In one embodiment, the first message comprises at least one IE RadioLinkMonitoringConfig.

In one embodiment, the first message comprises at least one failureDetectionResourcesToAddModList field.

In one embodiment, the first message comprises a failureDetectionResourcesToAddModList field.

In one embodiment, at least one IE or at least one field other than an IE RadioLinkMonitoringConfig in the first message indicates the first RS resource set.

In one embodiment, the at least one RS resource in the first RS resource group is used for a BFR procedure.

In one embodiment, the at least one RS resource in the first RS resource group is used for a Beam Failure Detection procedure.

In one embodiment, one RS resource in the first RS resource group is a Dedicated demodulation reference signal (DMRS) resource.

In one embodiment, one RS resource in the first RS resource group is a Phase-tracking reference signal (PTRS).

In one embodiment, one RS resource in the first RS resource group is a Channel state information Reference signal (CSI-RS) resource.

In one embodiment, one RS resource in the first RS resource group is a Synchronization Signal Block (SSB) resource.

In one embodiment, one RS resource in the first RS resource group is a Synchronization Signal (SS)/ Physical Broadcast Channel (PBCH) block.

In one embodiment, one RS resource in the first RS resource group is a CSI-RS resource identified by a csi-RS-Index, or the RS resource is an SSB resource identified by a ssb-Index.

In one embodiment, one RS resource in the first RS resource group is a CSI-RS resource identified by a csi-rs, or the RS resource is an SSB resource identified by an ssb.

In one embodiment, one RS resource in the first RS resource group is a CSI-RS resource identified by a NZP-CSI-RS-ResourceId, or the RS resource is an SSB resource identified by an SSB-Index.

In one embodiment, any RS resource in the first RS resource group is periodic.

In one embodiment, any RS resource in the first RS resource group is aperiodic.

In one embodiment, any RS resource in the first RS resource group is QCL-Type D.

In one embodiment, the at least one RS resource in the second RS resource group is used for a BFR procedure.

In one embodiment, the at least one RS resource in the second RS resource group is used for a beam failure detection.

In one embodiment, one RS resource in the second RS resource group is a CSI-RS resource.

In one embodiment, one RS resource in the second RS resource group is an SSB resource.

In one embodiment, one RS resource in the second RS resource group is an SS/PBCH.

In one embodiment, one RS resource in the second RS resource group is a CSI-RS resource identified by a csi-RS-Index or an SSB resource identified by an ssb-Index.

In one embodiment, an RS resource in the second RS resource group is a CSI-RS resource identified by a csi-rs or an SSB resource identified by an ssb.

In one embodiment, any RS resource in the first RS resource group is a CSI-RS resource identified by a NZP-CSI-RS-ResourceId or an SSB resource identified by an SSB-Index.

In one embodiment, any RS resource in the second RS resource group is periodic.

In one embodiment, any RS resource in the second RS resource group is aperiodic.

In one embodiment, any RS resource in the second RS resource group is QCL-Type D.

In one embodiment, the phrase of radio link quality evaluated according to the first RS resource group being worse than a first threshold comprises: the radio link quality evaluated according to the first RS resource group is greater than the first threshold; the first threshold comprises a Block Error Ratio (BLER) threshold.

In one embodiment, the phrase of radio link quality evaluated according to the first RS resource group being worse than a first threshold comprises: the radio link quality evaluated according to the first RS resource group is less than the first threshold; the first threshold comprises a BLER threshold.

In one embodiment, the phrase of radio link quality evaluated according to the first RS resource group being worse than a first threshold comprises: the radio link quality evaluated according to the first RS resource group is worse than the first threshold; the first threshold comprises at least one of a Reference Signal Received Power (RSRP) threshold, or a Reference Signal Received Power (RSRQ) threshold, or a Signal to Interference plus Noise Ratio (SINR) threshold.

In one embodiment, the phrase of radio link quality evaluated according to the first RS resource group being worse than a first threshold comprises: the radio link quality evaluated according to the first RS resource group is not greater than the first threshold.

In one embodiment, the phrase of “whenever radio link quality evaluated according to the first RS resource group being worse than a first threshold, increasing a first counter by 1” comprises: whenever radio link quality evaluated according to the first RS resource group is worse than a first threshold, a physical layer of the first node U01 transmits a first indication to a higher layer of the first node U01, and when the higher layer of the first node U01 receives the first indication, a first counter is increased by 1.

In one embodiment, whenever radio link quality evaluated according to the first RS resource group is worse than a first threshold, in a reporting period corresponding to the first evaluation period, a physical layer of the first node U01 transmits a first indication to a higher layer of the first node U01, and when the higher layer of the first node U01 receives the first indication, a first counter is increased by 1.

In one embodiment, the first indication is a beam failure instance indication.

In one embodiment, the first indication is used to indicate that a beam failure instance for the first RS resource group is detected.

In one embodiment, the phrase of “whenever radio link quality evaluated according to the first RS resource group being worse than a first threshold, increasing a first counter by 1” comprises: radio link quality is evaluated according to the first RS resource group in each first evaluation period, and if radio link quality evaluated according to the first RS resource group is worse than a first threshold, a first counter is increased by 1.

In one embodiment, the phrase of radio link quality evaluated according to the first RS resource group comprises radio link quality acquired after performing a measurement on at least one RS resource in the first RS resource group.

In one embodiment, the phrase of radio link quality evaluated according to the first RS resource group comprises radio link quality acquired after performing a measurement on each RS resource in the first RS resource group.

In one embodiment, the phrase of radio link quality evaluated according to the first RS resource group comprises radio link quality acquired after performing a measurement on at least one RS resource in a subset in the first RS resource group.

In one embodiment, the phrase of radio link quality evaluated according to the first RS resource group comprises radio link quality acquired after performing a measurement on each RS resource in a subset in the first RS resource group.

In one embodiment, the above one subset in the first RS resource group comprises at least one RS resource.

In one embodiment, a number of RS resources in the above one subset in the first RS resource group is not greater than a number of RS resources in the first RS resource group.

In one embodiment, the phrase of radio link quality evaluated according to the second RS resource group being worse than a second threshold comprises: the radio link quality evaluated according to the second RS resource group is greater than the second threshold; the second threshold comprises a Block Error Ratio (BLER) threshold.

In one embodiment, the phrase of radio link quality evaluated according to the second RS resource group being worse than a second threshold comprises: the radio link quality evaluated according to the second RS resource group is less than the second threshold; the second threshold comprises a BLER threshold.

In one embodiment, the phrase of radio link quality evaluated according to the second RS resource group being worse than a second threshold comprises: the radio link quality evaluated according to the second RS resource group is less than the second threshold; the second threshold comprises at least one of an RSRP threshold, or an RSRQ threshold, or an SINR threshold.

In one embodiment, the phrase of radio link quality evaluated according to the second RS resource group being worse than a second threshold comprises: the radio link quality evaluated according to the second RS resource group is not greater than the second threshold.

In one embodiment, the phrase of “whenever radio link quality evaluated according to the second RS resource group being worse than a second threshold, increasing a second counter by 1” comprises: whenever radio link quality evaluated according to the second RS resource group is worse than a second threshold, a physical layer of the first node U01 transmits a second indication to a higher layer of the first node U01, and when the higher layer of the first node U01 receives the second indication, a second counter is increased by 1.

In one embodiment, whenever radio link quality evaluated according to the second RS resource group is worse than a second threshold, in a reporting period corresponding to the second evaluation period, a physical layer of the first node U01 transmits a second indication to a higher layer of the first node U01, and when the higher layer of the first node U01 receives the second indication, a second counter is increased by 1.

In one embodiment, the second indication is a beam failure instance indication.

In one embodiment, the second indication is used to indicate that a beam failure instance for the second RS resource group is detected.

In one embodiment, the phrase of “whenever radio link quality evaluated according to the second RS resource group being worse than a second threshold, increasing a second counter by 1” comprises: radio link quality is evaluated according to the second RS resource group in each second evaluation period, and if radio link quality evaluated according to the second RS resource group is worse than a second threshold, a second counter is increased by 1.

In one embodiment, the phrase of radio link quality evaluated according to the second RS resource group comprises radio link quality acquired after performing a measurement on at least one RS resource in the second RS resource group.

In one embodiment, the phrase of radio link quality evaluated according to the second RS resource group comprises radio link quality acquired after performing a measurement on each RS resource in the second RS resource group.

In one embodiment, the phrase of radio link quality evaluated according to the second RS resource group comprises radio link quality acquired after performing a measurement on at least one RS resource in a subset in the second RS resource group.

In one embodiment, the phrase of radio link quality evaluated according to the second RS resource group comprises radio link quality acquired after performing a measurement on each RS resource in a subset in the second RS resource group.

In one embodiment, the above one subset in the second RS resource group comprises at least one RS resource.

In one embodiment, a number of RS resources in the above one subset in the second RS resource group is not greater than a number of RS resources in the second RS resource group.

In one embodiment, the meaning of whenever comprises: once, or as long as, or if, or only if.

In one embodiment, the meaning of the evaluation comprises at least one of measuring, or filter, or processing, or comparing, or analyzing, or computing, or counting.

In one embodiment, the radio link quality comprises at least one of an RSRP measurement result or an RSRQ measurement result or an SINR measurement result or a BLER measurement result.

In one embodiment, the higher layer is a MAC layer.

In one embodiment, the reporting period comprises at least one slot.

In one embodiment, the reporting period is 2 ms.

In one embodiment, the reporting period is 10 ms.

In one embodiment, the reporting period is a shortest period of all RS resources in the RS resource sub-group.

In one embodiment, one evaluation period comprises a time interval of at least one 1 ms.

In one embodiment, one evaluation period is one frame.

In one embodiment, one evaluation period is one radio frame.

In one embodiment, the above evaluation period comprises the first evaluation period.

In one embodiment, the above evaluation period comprises the second evaluation period.

In one embodiment, the first evaluation period is the same as the second evaluation period.

In one embodiment, the first evaluation period is different the second evaluation period.

In one embodiment, the first evaluation period and the second evaluation period are aligned in time.

In one embodiment, a start time of the first evaluation period is the same as a start time of the second evaluation period, and an end time of the first evaluation is the same as an end time of the second evaluation period.

In one embodiment, the first evaluation period and the second evaluation period are not aligned in time.

In one embodiment, a reporting period corresponding to the first evaluation period is the same as a reporting period corresponding to the second evaluation period.

In one embodiment, a reporting period corresponding to the first evaluation period is different from a reporting period corresponding to the second evaluation period.

In one embodiment, one evaluation period comprises at least one slot, and the slot comprises at least one of slot, or subframe, or radio frame, or frame, or multiple Orthogonal Frequency Division Multiplexing (OFDM) symbols, or multiple Single Carrier Frequency Division Multiple Access (SC-FDMA) symbols.

In one embodiment, the at least one RS resource in the first RS resource group belongs to a TRP, and the at least one RS resource in the second RS resource group belongs to another TRP.

In one embodiment, the at least one RS resource in the first RS resource group is used for a link recovery procedure for a TRP, and the at least one RS resource in the second RS resource group is used for a link recovery procedure for another TRP.

In one embodiment, the at least one RS resource in the first RS resource group is used to determine whether a TRP has a beam failure, and the at least one RS resource in the second RS resource group is used to determine whether another TRP has a beam failure.

In one embodiment, both the above TRP and the above another TRP belong to the first cell.

In one embodiment, the first RS resource group correspond to one q̅̅̅₀, and the second RS resource group corresponds to another q̅̅̅₀.

In one embodiment, the first RS resource group is one q̅̅̅₀, and the second RS resource group is another q̅̅̅₀.

In one embodiment, a name of the first RS resource group comprises q̅̅̅₀, and a name of the second RS resource group comprises q̅̅̅₀.

In one embodiment, both the first RS resource group and the second RS resource group belong to the first cell.

In one embodiment, both the first RS resource group and the second RS resource group are associated with a first cell.

In one embodiment, the above TRP belongs to the first cell, and the above another TRP belongs to the second cell.

In one embodiment, the first RS resource group belongs to the first cell, and the second RS resource group belongs to the second cell.

In one embodiment, the phrase of the first candidate RS resource being associated with the first RS resource group comprises: the first candidate RS resource is used for a BFR for the first RS resource group.

In one embodiment, the phrase of the first candidate RS resource being associated with the first RS resource group comprises: the first candidate RS resource is a candidate RS resource configured for the first RS resource group.

In one embodiment, the phrase of the first candidate RS resource being associated with the first RS resource group comprises: when a beam failure for the first RS resource group is detected, the first candidate RS resource is evaluated; when a beam failure for the second RS resource group is detected, the first candidate RS resource is not evaluated.

In one embodiment, the phrase of the first candidate RS resource being associated with the first RS resource group comprises: when a beam failure for the first RS resource group is detected, the first candidate RS resource can be used for a candidate beam; when a beam failure for the second RS resource group is detected, the first candidate RS resource is not used for a candidate beam.

In one embodiment, the phrase of at least a former of the first counter reaching a first value or the second counter reaching a second value being used to determine to initiate the first random access procedure comprises: at least a former of a beam failure being detected for the first RS resource group or a beam failure being detected for the second RS resource group is used to determine the first random access procedure.

In one embodiment, the phrase of at least a former of the first counter reaching a first value or the second counter reaching a second value being used to determine to initiate the first random access procedure comprises: the first random access procedure is related to the first counter reaching the first value.

In one embodiment, the phrase of at least a former of the first counter reaching a first value or the second counter reaching a second value being used to determine to initiate the first random access procedure comprises: the first random access procedure is related to the first counter reaching the first value and the second counter reaching the second value.

In one embodiment, the phrase of at least a former of the first counter reaching a first value or the second counter reaching a second value being used to determine to initiate the first random access procedure comprises: the first counter reaching the first value is used to determine to initiate the first random access procedure.

In one embodiment, the phrase of at least a former of the first counter reaching a first value or the second counter reaching a second value being used to determine to initiate the first random access procedure comprises: the first counter reaching the first value and the second counter reaching the second value is used to initiate the first random access procedure.

In one embodiment, the first counter reaching the first value is used to determine that a beam failure for the first RS resource group is detected.

In one embodiment, the second counter reaching the second value is used to determine that a beam failure for the second RS resource group is detected.

In one embodiment, the first threshold is equal to the second threshold.

In one embodiment, the first threshold is not equal to the second threshold.

In one embodiment, a unit for measurement of the first threshold and a unit for measurement of the second threshold are the same.

In one embodiment, the first threshold and the second field value are configured in different RRC messages.

In one embodiment, the first threshold and the second threshold are configured in different RRC fields in a same RRC message.

In one embodiment, the first threshold is pre-configured.

In one embodiment, the first threshold is configured through an RRC message.

In one embodiment, the first threshold comprises a Block Error Ratio (BLER) threshold.

In one embodiment, the first threshold comprises an RSRP threshold

In one embodiment, the first threshold comprises Qₒᵤₜ.

In one embodiment, the first threshold is indicated by a field in an RRC message.

In one embodiment, the first threshold is indicated by a field in an RRC message, and a name of the field comprises rlmInSyncOutOfSyncThreshold.

In one embodiment, the first threshold is indicated by a field in an RRC message, and a name of the field comprises rsrp-ThresholdSSB.

In one embodiment, the first threshold is indicated by a field in an RRC message, and a name of the field comprises rsrp-ThresholdBFR.

In one embodiment, the second threshold is pre-configured.

In one embodiment, the second threshold is configured through an RRC message.

In one embodiment, the second threshold comprises a Block Error Ratio (BLER) threshold.

In one embodiment, the second threshold comprises an RSRP threshold.

In one embodiment, the second threshold comprises Qₒᵤₜ.

In one embodiment, the second threshold is indicated by a field in an RRC message.

In one embodiment, the second threshold is indicated by a field in an RRC message, and a name of the field comprises rlmInSyncOutOfSyncThreshold.

In one embodiment, the second threshold is indicated by a field in an RRC message, and a name of the field comprises rsrp-ThresholdSSB.

In one embodiment, the second threshold is indicated by a field in an RRC message, and a name of the field comprises rsrp-ThresholdBFR.

In one embodiment, the first value is equal to the second value.

In one embodiment, the first value is different from the second value.

In one embodiment, the first value is equal to beamFailureInstanceMaxCount.

In one embodiment, the first value is configured by beamFailureInstanceMaxCount.

In one embodiment, the first value is equal to a value of a parameter whose name comprises beamFailureInstanceMaxCount.

In one embodiment, the first value is configured by a parameter whose name comprises beamFailureInstanceMaxCount.

In one embodiment, the first value is equal to a value of a parameter, and a name of the parameter comprises at least one of beam or Failure or Instance or Max or Count or TRP or RS or Set or per.

In one embodiment, the first value is not greater than 512.

In one embodiment, the first value is not greater than 10.

In one embodiment, the second value is equal to beamFailureInstanceMaxCount.

In one embodiment, the second value is configured by beamFailureInstanceMaxCount.

In one embodiment, the second value is equal to a value of a parameter whose name comprises beamFailureInstanceMaxCount.

In one embodiment, the second value is configured by a parameter whose name comprises beamFailureInstanceMaxCount.

In one embodiment, the second value is equal to a value of a parameter, and a name of the parameter comprises at least one of beam or Failure or Instance or Max or Count or TRP or RS or Set or per.

In one embodiment, the second value is not greater than 512.

In one embodiment, the second value is not greater than 10.

In one embodiment, the first counter reaching the first value refers to: when the first counter is increased by 1, the first counter reaches the first value.

In one embodiment, the first counter reaching the first value refers to: the first counter increased by 1 reaches the first value.

In one embodiment, the first BFR is a BFR associated with the first RS resource group.

In one embodiment, the first BFR belongs to the first RS resource group.

In one embodiment, the first BFR is associated with the first RS resource group.

In one embodiment, whether the first BFR is triggered depends on the first counter.

In one embodiment, the first BFR does not belong to the second RS resource group.

In one embodiment, the first BFR is associated with the second RS resource group.

In one embodiment, whether the first BFR is triggered does not depend on the second counter.

In one embodiment, PUCCH resources associated with the first SR belong to the first cell.

In one embodiment, PUCCH resources associated with the first SR belong to a TRP of the first cell.

In one embodiment, PUCCH resources associated with the first SR belong to a TRP to which the first candidate RS resource belongs.

In one embodiment, the first BFR being triggered and there being not sufficient PUSCH resources are used to determine to trigger the first SR.

In one embodiment, as a response to at least one BFR of the first RS resource group being triggered and not being canceled and an evaluation for a candidate beam of the first RS resource group having been completed, if there are not available UL-SCH resources used for a new transmission or available UL-SCH resources cannot accommodate a MAC CE having any candidate format in the second candidate format set and a sub-header of the MAC CE, the first SR is triggered.

In one embodiment, the first SR being triggered and there being not efficient PUCCH resources for the first SR are used to determine to initiate the first random access procedure.

In one embodiment, as a response to the first SR being triggered and a pending state, the first random access procedure is initiated on the first cell.

In one embodiment, as a response to the first SR being triggered, and if a MAC entity does not have efficient PUCCH resources configured for the first SR, the first random access procedure is initiated.

In one embodiment, as a response to the first SR being triggered and a pending state, if a MAC entity does not have efficient PUCCH resources configured for the first SR, the first random access procedure is initiated on the first cell.

In one embodiment, as a response to the first random access procedure is initiated, the first SR is canceled.

In one embodiment, as a response to the first counter reaching the first value and the second counter reaching the second value, and if a random access procedure triggered by an SR triggered by a given BFR is not executed, the first random access procedure is initiated.

### Embodiment 8

Embodiment 8 illustrates a flowchart of radio signal transmission according to another embodiment in the present application, as shown in FIG. 8. It is particularly underlined that the order illustrated in the embodiment does not put constraints over sequences of signal transmissions and implementations.

The first node U01, in step S8101, receives a first message, the first message indicates at least a first RS resource group and a second RS resource group, the first RS resource group comprises at least one RS resource, and the second RS resource group comprises at least one RS resource; in step S8102, whenever radio link quality evaluated according to the first RS resource group is worse than a first threshold, increases a first counter by 1; in step S8103, whenever radio link quality evaluated according to the second RS resource group is worse than a second threshold, increases a second counter by 1; in step S8104, the first counter reaches the first value and the second counter reaches the second value; in step S8105, as a response to the first counter reaching the first value and the second counter reaching the second value, initiating the first random access procedure.

The second node N02, in step S8201, transmits the first message.

In embodiment 8, the first signaling satisfies all conditions in a first condition set; one condition comprised in the first condition set is that the first signaling is identified by a first RNTI, and the first RNTI is allocated to the first node U01; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1; the first RS resource group and the second RS resource group belong to a same serving cell; the first candidate RS resource is associated with the first RS resource group; at least a former of the first counter reaching a first value or the second counter reaching a second value is used to determine to initiate the first random access procedure; the first threshold and the second threshold are configurable; the first value and the second value are configurable, and the first value and the second value are respectively a positive integer.

In one embodiment, the phrase of the first counter reaching the first value and the second counter reaching the second value can be replaced as any of the following sentences:
the first BFR is triggered, and the second BFR is triggered;
the first BFR is triggered, and the second BFR is triggered, and the first BFR and the second BFR are in a pending state;
the first BFR is triggered, and the second BFR is triggered, and both the first BFR and the second BFR are not completed;
the first BFR is triggered, and the second BFR is triggered, and both the first BFR and the second BFR are not canceled;
the first BFR is triggered, and the first BFR is in a pending state, and the second counter reaches the second value;
the first BFR is triggered, and the first BFR is not completed, and the second counter reaches the second value;
the first BFR is triggered, and the first BFR is not completed, and the second BFR is triggered;
at least the first counter reaches the first value and the second counter reaches the second value.

In one embodiment, after the first counter reaching the first value and the second counter reaching the second value, the first random access procedure is initiated.

In one embodiment, the first counter reaching the first value and the second counter reaching the second value are used to trigger that the first random access procedure is initiated.

In one embodiment, a beam failure for the first RS resource group being detected and a beam failure for the second RS resource group being detected are used to determine to initiate the first random access procedure.

In one embodiment, the second counter reaching the second value refers to: when the second counter is increased by 1, the second counter reaches the second value.

In one embodiment, the second counter reaching the second value refers to: the second counter increased by 1 reaches the second value.

In one embodiment, the behavior of triggering a second BFR comprises triggering BFR for the second RS resource group.

In one embodiment, the behavior of triggering a second BFR comprises triggering an enhanced BFR for the second RS resource group.

In one embodiment, the second BFR is a BFR associated with the second RS resource group.

In one embodiment, the second BFR belongs to the second RS resource group.

In one embodiment, the second BFR is associated with the second RS resource group.

In one embodiment, whether the second BFR is triggered depends on the second counter.

In one embodiment, the second BFR does not belong to the first RS resource group.

In one embodiment, the second BFR is associated with the second RS resource group.

In one embodiment, whether the second BFR is triggered does not depend on the first counter.

In one embodiment, the first BFR and the second BFR cannot triggered at the same time.

In one embodiment, the first BFR and the second BFR can be triggered at the same time.

In one embodiment, as a response to the first counter reaching the first value and the second counter reaching the second value, and if a random access procedure triggered by an SR triggered by a given BFR is executed, the random access procedure is stopped and the first random access procedure is initiated.

In one embodiment, as a response to the first counter reaching the first value and the second counter reaching the second value, and if a random access procedure triggered by an SR triggered by a given BFR is not executed, the first random access procedure is initiated.

In one embodiment, as a response to the first counter reaching the first value and the second counter reaching the second value, a random access procedure triggered by an SR triggered by a given BFR is executed is used to determine not to initiate the first random access procedure.

In one embodiment, the given BFR is the first BFR.

In one embodiment, the given BFR is the second BFR.

In one embodiment, the given BFR is at least one of the first BFR or the second BFR.

In one embodiment, the given BFR is BFR triggered for an SCell in a cell group to which the first cell belongs.

In one embodiment, the given BFR is BFR triggered for an RS resource group in a serving cell in a cell group to which the first cell belongs.

In one embodiment, the random access procedure triggered by the SR triggered by a given BFR refers to: since the SR triggered by the given BFR is in a pending state and there’s no random access procedure triggered by available PUCCH resources.

In one embodiment, the SR being triggered by the given BFR refers to: since the given BFR is triggered, and the given BFR is in a pending state, and an evaluation for a candidate beam of the given BFR has been completed, and there is no available UL-SCH resource or available UL-SCH resources cannot accommodate an SR triggered by a MAC CE having any candidate format of the second candidate format set and a sub-header of the MAC CE.

In one embodiment, PUCCH resources associated with the SR triggered by the given BFR belong to the first cell.

In one embodiment, PUCCH resources configured for the SR triggered by the given BFR are associated with the first cell.

### Embodiment 9

Embodiment 9 illustrates a schematic diagram of a PDCCH used for carrying a first signaling and a first candidate RS resource having same antenna port QCL properties according to one embodiment of the present application, as shown in FIG. 9.

In embodiment 9, a PDCCU used for carrying the first signaling has same antenna port QCL properties with the first candidate RS resource.

In one embodiment, the meaning of the phrase of a PDCCU used for carrying the first signaling having same antenna port QCL properties with the first candidate RS resource comprises: the first node adopts QCL parameter(s) associated with the first candidate RS resource to receive the first signaling.

In one embodiment, the meaning of the phrase of a PDCCU used for carrying the first signaling having same antenna port QCL properties with the first candidate RS resource comprises: the first node receives the first signaling on a PDCCH QCL to the first candidate RS resource.

In one embodiment, the meaning of the phrase of a PDCCU used for carrying the first signaling having same antenna port QCL properties with the first candidate RS resource comprises: the first node monitors a PDCCH and receives the first signaling according to QCL parameters associated with the first candidate RS resource.

In one embodiment, the meaning of the phrase of a PDCCU used for carrying the first signaling having same antenna port QCL properties with the first candidate RS resource comprises: antenna port QCL properties of a PDCCH used to carry the first signaling have same antenna port QCL properties with the first candidate RS resource.

In one embodiment, the meaning of the phrase of a PDCCU used for carrying the first signaling having same antenna port QCL properties with the first candidate RS resource comprises: the first node assumes that a PDCCU used for carrying the first signaling has same antenna port QCL properties with the first candidate RS resource.

In one embodiment, the carrying refers to: carry.

In one embodiment, the antenna port QCL properties refer to: the QCL parameter(s) associated with the first candidate RS resource.

In one embodiment, the antenna port QCL properties refer to: DM-RS antenna port quasi co-location properties

In one embodiment, the antenna port QCL properties refer to: DM-RS antenna port quasi co-location properties.

In one embodiment, the antenna port QCL properties refer to TS 38.214.

In one embodiment, the meaning of QCL refers to: channel properties on some antenna port symbol can be inferred from another antenna port.

In one embodiment, the first signaling being transmitted on a PDCCH refers to: the first signaling is transmitted on a PDCCH with a same antenna port QCL properties with the first candidate RS resource.

In one embodiment, the first signaling being transmitted on a PDCCH refers to: the first signaling is transmitted on a PDCCH of the first cell.

In one embodiment, the first node receives the first signaling on a PDCCH having same antenna port QCL properties with the first candidate RS resource.

In one embodiment, the first node receives the first signaling on a PDCCH of the first cell.

### Embodiment 10

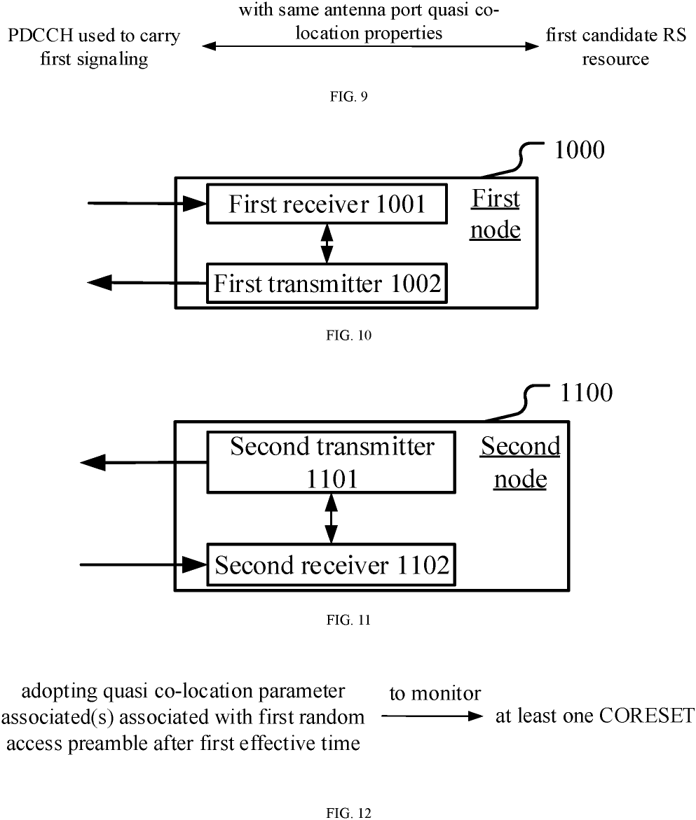

Embodiment 10 illustrates a structure block diagram of a processor in a first node according to one embodiment of the present application, as shown in FIG. 10. In FIG. 10, a processor 1000 in a first node comprises a first receiver 1001 and a first transmitter 1002.

The first transmitter 1002 transmits a first radio signal, the first radio signal comprises a first MAC CE, the first MAC CE is used for a BFR, a format of the first MAC CE is a candidate format in a first candidate format set or a candidate format in a second candidate format set, the first MAC CE is used to determine a first candidate RS resource;

the first receiver 1001 receives a first signaling, the first signaling is transmitted on a PDCCH; as a response to receiving the first signaling, monitors at least one CORESET with QCL parameter(s) associated with the first candidate RS resource after a first effective time, the first signaling is used to indicate the first effective time;

In embodiment 10, the first signaling satisfies all conditions in a first condition set; one condition comprised in the first condition set is that the first signaling is identified by a first RNTI, and the first RNTI is allocated to the first node; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.

In one embodiment, the first transmitter 1002, as a response to receiving the first signaling, adopts a spatial filter associated with the first candidate RS resource to transmit a PUCCH after the first effective time.

In one embodiment, a PDCCU used for carrying the first signaling has same antenna port QCL properties with the first candidate RS resource.

In one embodiment, the first transmitter 1002, transmits a first random access preamble in a first random access procedure, the first random access preamble is used to determine a first uplink grant; herein, the first uplink grant is used to carry the first radio signal; the first signaling is used to determine that the first random access procedure is successfully completed; when the format of the first MAC CE is a candidate format in the second candidate format set, one condition comprised in the first condition set is that the first signaling is used to determine that the first random access procedure is successfully completed.

In one embodiment, the first receiver 1001, receives a first message, the first message indicates at least a first RS resource group and a second RS resource group, the first RS resource group comprises at least one RS resource, and the second RS resource group comprises at least one RS resource; whenever radio link quality evaluated according to the first RS resource group is worse than a first threshold, increasing a first counter by 1; whenever radio link quality evaluated according to the second RS resource group is worse than a second threshold, increasing a second counter by 1; herein, the first RS resource group and the second RS resource group belong to a same serving cell; the first candidate RS resource is associated with the first RS resource group; at least a former of the first counter reaching a first value or the second counter reaching a second value is used to determine to initiate the first random access procedure; the first threshold and the second threshold are configurable; the first value and the second value are configurable, and the first value and the second value are respectively a positive integer.

In one embodiment, the first transmitter 1002, as a response to the first counter reaching the first value and the second counter reaching the second value, initiates the first random access procedure.

In one embodiment, as a response to the first counter reaching the first value, a first BFR is triggered; as a response to the first BFR being triggered, a first SR is triggered; as a response to the first SR being triggered, the first random access procedure is initiated;

In one embodiment, the first receiver 1001 comprises the antenna 452, the receiver 454, the multi-antenna receiving processor 458, the receiving processor 456, the controller/ processor 459, the memory 460 and the data source 467 in FIG. 4 of the present application.

In one embodiment, the first receiver 1001 comprises the antenna 452, the receiver 454, the multi-antenna receiving processor 458 and the receiving processor 456 in FIG. 4 of the present application.

In one embodiment, the first receiver 1001 comprises the antenna 452, the receiver 454 and the receiving processor 456 in FIG. 4 of the present application.

In one embodiment, the first transmitter 1002 comprises the antenna 452, the transmitter 454, the multi-antenna transmitting processor 457, the transmitting processor 468, the controller/ processor 459, the memory 460, and the data source 467 in FIG. 4 of the present application.

In one embodiment, the first transmitter 1002 comprises the antenna 452, the transmitter 454, the multi-antenna transmitting processor 457 and the transmitting processor 468 in FIG. 4 of the present application.

In one embodiment, the first transmitter 1002 comprises the antenna 452, the transmitter 454 and the transmitting processor 468 in FIG. 4 of the present application.

### Embodiment 11

Embodiment 11 illustrates a structure block diagram of a processor in a second node according to one embodiment of the present application, as shown in FIG. 11. In FIG. 11, a processor 1100 in a second node comprises a second transmitter 1101 and a second receiver 1102.

The second receiver 1102 receives a first radio signal, the first radio signal comprises a first MAC CE, the first MAC CE is used for a BFR, a format of the first MAC CE is a candidate format of a first candidate format set or a candidate format of a second candidate format set, the first MAC CE is used to determine a first candidate RS resource;

the second transmitter 1101, transmits a first signaling, and the first signaling is transmitted on a PDCCH;

In embodiment 11, as a response to the first signaling being received by a transmitter of the first radio signal, a transmitter of the first radio signal monitors at least one CORESET with QCL parameter(s) associated with the first candidate RS resource after a first effective time, the first signaling is used to indicate the first effective time; the first signaling satisfies all conditions in a first condition set; one condition comprised in the first condition set is that the first signaling is identified by a first RNTI, and the first RNTI is allocated to a transmitter of the first radio signal; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.

In one embodiment, the first transmitter 1101 receives a PUCCH; herein, as a response to the first signaling being received by a transmitter of the first radio signal, a transmitter of the first radio signal transmits a PUCCH with a spatial filer associated with the first candidate RS resource after the first effective time.

In one embodiment, a PDCCU used for carrying the first signaling has same antenna port QCL properties with the first candidate RS resource.

In one embodiment, the second receiver 1102 receives a first random access preamble in a first random access procedure, and the first random access preamble is used to determine a first uplink grant; herein, the first uplink grant is used to carry the first radio signal; the first signaling is used to determine that the first random access procedure is successfully completed; when the format of the first MAC CE is a candidate format in the second candidate format set, one condition comprised in the first condition set is that the first signaling is used to determine that the first random access procedure is successfully completed.

In one embodiment, the second transmitter 1101 transmits a first message, the first message indicates at least a first RS resource group and a second RS resource group, the first RS resource group comprises at least one RS resource, and the second RS resource group comprises at least one RS resource; herein, whenever radio link quality evaluated according to the first RS resource group is worse than a first threshold, a first counter is increased by 1; whenever radio link quality evaluated according to the second RS resource group is worse than a second threshold, a second counter is increased by 1; the first RS resource group and the second RS resource group belong to a same serving cell; the first candidate RS resource is associated with the first RS resource group; at least a former of the first counter reaching a first value or the second counter reaching a second value is used to determine to initiate the first random access procedure; the first threshold and the second threshold are configurable; the first value and the second value are configurable, and the first value and the second value are respectively a positive integer.

In one embodiment, as a response to the first counter reaching the first value and the second counter reaching the second value, the first random access procedure is initiated.

In one embodiment, as a response to the first counter reaching the first value, a first BFR is triggered; as a response to the first BFR being triggered, a first SR is triggered; the first SR being triggered is used to determine to initiate the first random access procedure.

In one embodiment, the second transmitter 1101 comprises the antenna 420, the transmitter 418, the multi-antenna transmitting processor 471, the transmitting processor 416, the controller/ processor 475 and the memory 476 in FIG. 4 of the present application.

In one embodiment, the second transmitter 1101 comprises the antenna 420, the transmitter 418, the multi-antenna transmitting processor 471 and the transmitting processor 416 in FIG. 4 of the present application.

In one embodiment, the second transmitter 1101 comprises the antenna 420, the transmitter 418 and the transmitting processor 416 in FIG. 4 of the present application.

In one embodiment, the second receiver 1102 comprises the antenna 420, the receiver 418, the multi-antenna receiving processor 472, the receiving processor 470, the controller/ processor 475 and the memory 476 in FIG. 4 of the present application.

In one embodiment, the second receiver 1102 comprises the antenna 420, the receiver 418, the multi-antenna receiving processor 472 and the receiving processor 470 in FIG. 4 of the present application.

In one embodiment, the second receiver 1102 comprises the antenna 420, the receiver 418 and the receiving processor 470 in FIG. 4 of the present application.

### Embodiment 12

Embodiment 12 illustrates a schematic diagram of monitoring at least one CORESET with QCL parameter(s) associated with a first random access preamble after a first effective time, as shown in FIG. 12.

In embodiment 12, as a response to receiving the first signaling, at least one CORESET is monitored with QCL parameter(s) associated with the first random access preamble after the first effective time; herein, the format of the first MAC CE is a candidate format in the second candidate format set, one condition comprised in the first condition set is that the first signaling is used to determine that the first random access procedure is successfully completed; the first condition set does not comprise the first target condition; the first candidate RS resource is a only candidate RS resource indicated by the first MAC CE for the first cell; the first cell is a PCell.

In one embodiment, the first candidate RS resource and an RS resource used for the first random access preamble are associated with two different TRPs of the first cell.

In one embodiment, the first candidate RS resource is associated with the first RS resource group, and an RS resource used for the first random access preamble is associated with the second RS resource group.

In one embodiment, the first candidate RS resource is associated with a TRP corresponding to the first RS resource group, and an RS resource used for the first random access preamble is associated with a TRP corresponding to the second RS resource group.

In one embodiment, as a response to receiving the first signaling, at least one CORESET is monitored with QCL parameter(s) associated with the first candidate RS resource after a first effective time, and at least one CORESET is monitored with QCL parameter(s) associated with the first random access preamble after the first effective time.

In one embodiment, as a response to receiving the first signaling, a spatial filter associated with the first candidate RS resource is adopted to transmit a PUCCH after the first effective time, or, a PUCCH is transmitted by adopting a spatial filter associated with the first random access preamble after the first effective time.

In one embodiment, as a response to receiving the first signaling, a spatial filter associated with the first candidate RS resource is adopted to transmit a PUCCH after the first effective time, or, a PUCCH is transmitted by adopting a spatial filter associated with the first random access preamble after the first effective time.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first transmitter, transmitting a first radio signal, the first radio signal comprising a first Medium Access Control Control Element (MAC CE), the first MAC CE being used for a Beam Failure Recovery (BFR), a format of the first MAC CE being a candidate format in a first candidate format set or a candidate format in a second candidate format set, the first MAC CE being used to determine a first candidate Reference Signal (RS) resource; and
a first receiver, receiving a first signaling, the first signaling being transmitted on a Physical Downlink Control Channel (PDCCH); as a response to receiving the first signaling, monitoring at least one Control Resource Set (CORESET) with Quasi Co-Location (QCL) parameter(s) associated with the first candidate RS resource after a first effective time, the first signaling being used to indicate the first effective time;
wherein the first signaling satisfies all conditions in a first condition set; one condition comprised in the first condition set is that the first signaling is identified by a first Radio Network Temporary Identifier (RNTI), and the first RNTI is allocated to the first node; whether the first condition set comprises a first target condition is related to whether the format of the first MAC CE is a candidate format in the first candidate format set or a candidate format in the second candidate format set; the first target condition is that the first signaling comprises a first Hybrid Automatic Repeat Request (HARQ) process number and comprises a toggled New Data Indicator (NDI) field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.

2. The first node according to claim 1, comprising:
the first transmitter, as a response to receiving the first signaling, adopting a spatial filter associated with the first candidate RS resource after the first effective time to transmit a Physical Uplink Control Channel (PUCCH).

3. The first node according to claim 1, wherein a PDCCH used to carry the first signaling has same antenna port Quasi Co-Location (QCL) properties with the first candidate RS resource.

4. The first node according to claim 1, comprising:
the first transmitter, transmitting a first random access preamble in a first random access procedure, the first random access preamble being used to determine a first uplink grant;
wherein the first uplink grant is used to carry the first radio signal; the first signaling is used to determine that the first random access procedure is successfully completed; when the format of the first MAC CE is a candidate format in the second candidate format set, one condition comprised in the first condition set is that the first signaling is used to determine that the first random access procedure is successfully completed.

5. The first node according to claim 4, comprising:
the first receiver, receiving a first message, the first message indicating at least a first RS resource group and a second RS resource group, the first RS resource group comprising at least one RS resource, and the second RS resource group comprising at least one RS resource; whenever radio link quality evaluated according to the first RS resource group is worse than a first threshold, increasing a first counter by 1; whenever radio link quality evaluated according to the second RS resource group is worse than a second threshold, increasing a second counter by 1;
wherein the first RS resource group and the second RS resource group belong to a same serving cell; the first candidate RS resource is associated with the first RS resource group; at least a former of the first counter reaching a first value or the second counter reaching a second value is used to determine to initiate the first random access procedure; the first threshold and the second threshold are configurable; the first value and the second value are configurable, and the first value and the second value are respectively a positive integer.

6. The first node according to claim 5, comprising:
the first transmitter, as a response to the first counter reaching the first value and the second counter reaching the second value, initiating the first random access procedure.

7. The first node according to claim 5, comprising:
the first transmitter, as a response to the first counter reaching the first value, a first BFR is triggered; as a response to the first BFR being triggered, a first SR is triggered; as a response to the first SR being triggered, the first random access procedure is initiated.

8. The first node according to claim 7, wherein as a response to the first random access procedure is initiated, the first SR is canceled.

9. The first node according to claim 7, wherein the phrase of at least a former of the first counter reaching a first value or the second counter reaching a second value being used to determine to initiate the first random access procedure comprises: the first random access procedure is related to the first counter reaching the first value and the second counter reaching the second value.

10. The first node according to claim 7, wherein as a response to at least one BFR of the first RS resource group being triggered and not being canceled and an evaluation for a candidate beam of the first RS resource group having been completed, there being no available UL-SCH resources used for a new transmission or available UL-SCH resources being not capable of accommodating a MAC CE with any candidate format in the second candidate format set and a sub-header of the MAC CE is used to triggered the first SR.

11. The first node according to claim 7, wherein PUCCH resources associated with the first SR belong to a Transmitter Receiver Point (TRP) to which the first candidate RS resource belongs.

12. The first node according to claim 1, wherein the first RS resource group belongs to the first cell, and the second RS resource group belongs to the second cell; a PCI of the first cell is different from a Physical Cell Identifier (PCI) of the second cell.

13. The first node according to claim 1, wherein a MAC sub-header corresponding to any candidate format in the first candidate format set is different from a MAC sub-header corresponding to any candidate format in the second candidate set.

14. The first node according to claim 1, wherein a candidate format in the second candidate format set corresponds to a Logical Channel ID (LCID) index, and the LCID index corresponds to an LCID code-point; the LCID index is not equal to 50 (the LCID code-point is not equal to 50), and the LCID index is not equal to 51 (the LCID code-point is not equal to 51).

15. The first node according to claim 1, wherein a candidate format in the second candidate set corresponds to an extended LCID (eLCID) index, and the eLCID index corresponds to an eLCID code-point; the eLCID index is not equal to 314 (the eLCID code-point is not equal to 250), and the eLCID index is not equal to 315 (the eLCID code-point is not equal to 251).

16. A second node for wireless communications, comprising:
a second receiver, receiving a first radio signal, the first radio signal comprising a first MAC CE, the first MAC CE being used for a BFR, a format of the first MAC CE being a candidate format in a first candidate format set or a candidate format in a second candidate format set, the first MAC CE being used to determine a first candidate RS resource; and
a second transmitter, transmitting a first signaling, the first signaling being transmitted on a PDCCH;
wherein as a response to the first signaling being received by a transmitter of the first radio signal, a transmitter of the first radio signal monitors at least one CORESET with QCL parameter(s) associated with the first candidate RS resource after a first effective time, the first signaling is used to indicate the first effective time; the first signaling satisfies all conditions in a first condition set; one condition comprised in the first condition set is that the first signaling is identified by a first RNTI, and the first RNTI is allocated to a transmitter of the first radio signal; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.

17. The second node according to claim 16, comprising:
the second receiver, receiving a first random access preamble in a first random access procedure, the first random access preamble being used to determine a first uplink grant;
wherein the first uplink grant is used to carry the first radio signal; the first signaling is used to determine that the first random access procedure is successfully completed; when the format of the first MAC CE is a candidate format in the second candidate format set, one condition comprised in the first condition set is that the first signaling is used to determine that the first random access procedure is successfully completed.

18. The second node according to claim 16, comprising:
the second transmitter, transmitting a first message, the first message indicating at least a first RS resource group and a second RS resource group, the first RS resource group comprising at least one RS resource, and the second RS resource group comprising at least one RS resource;
wherein whenever radio link quality evaluated according to the first RS resource group is worse than a first threshold, a first counter is increased by 1; whenever radio link quality evaluated according to the second RS resource group is worse than a second threshold, a second counter is increased by 1; the first RS resource group and the second RS resource group belong to a same serving cell; the first candidate RS resource is associated with the first RS resource group; at least a former of the first counter reaching a first value or the second counter reaching a second value is used to determine to initiate the first random access procedure; the first threshold and the second threshold are configurable; the first value and the second value are configurable, and the first value and the second value are respectively a positive integer.

19. A method in a first node for wireless communications, comprising:
transmitting a first radio signal, the first radio signal comprising a first MAC CE, the first MAC CE being used for a BFR, a format of the first MAC CE being a candidate format in a first candidate format set or a candidate format in a second candidate format set, the first MAC CE being used to determine a first candidate RS resource; and
receiving a first signaling, the first signaling being transmitted on a PDCCH; as a response to receiving the first signaling, monitoring at least one CORESET with QCL parameter(s) associated with the first candidate RS resource after a first effective time, the first signaling being used to indicate the first effective time;
wherein the first signaling satisfies all conditions in a first condition set; one condition comprised in the first condition set is that the first signaling is identified by a first RNTI, and the first RNTI is allocated to the first node; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.

20. A method in a second node for wireless communications, comprising:
receiving a first radio signal, the first radio signal comprising a first MAC CE, the first MAC CE being used for a BFR, a format of the first MAC CE being a candidate format in a first candidate format set or a candidate format in a second candidate format set, the first MAC CE being used to determine a first candidate RS resource; and
transmitting a first signaling, the first signaling being transmitted on a PDCCH;
wherein as a response to the first signaling being received by a transmitter of the first radio signal, a transmitter of the first radio signal monitors at least one CORESET with QCL parameter(s) associated with the first candidate RS resource after a first effective time, the first signaling is used to indicate the first effective time; the first signaling satisfies all conditions in a first condition set; one condition comprised in the first condition set is that the first signaling is identified by a first RNTI, and the first RNTI is allocated to a transmitter of the first radio signal; whether the first condition set comprises a first target condition is related to whether the format of the first MAC CE is a candidate format in the first candidate format set or a candidate format in the second candidate format set; the first target condition is that the first signaling comprises a first HARQ process number and comprises a toggled NDI field, and the first HARQ process number is a HARQ process number allocated to a PUSCH occupied by the first MAC CE; the first candidate format set comprises at least a first candidate format, and the first candidate format can only indicate one candidate RS resource for a serving cell at most; the second candidate format set comprises at least a second candidate format, and a maximum number of candidate RS resources that can be indicated by the second candidate format for a serving cell is greater than 1.
